(19) United States
(12) Patent Application Publication
(10) Pub. No.: US 2008/0262839 A1
(43) Pub. Date: Oct. 23, 2008

(54) Processing Control Device, Method Thereof, Program Thereof, and Recording Medium Containing the Program

(75) Inventors: Yoshiya Nonaka, Saitama (JP); Yoshio Sekine, Tokyo (JP); Nobuo Tarui, Saitama (JP); Ryoji Sugino, Tokyo (JP); Noritaka Nii, Saitama (JP); Masashi Aoyama, Tokyo (JP); Hirobumi Iwaji, Saitama (JP); Takeshi Mutoh, Saitama (JP)

Correspondence Address: KRATZ, QUINTOS & HANSON, LLP, 1420 K Street, N.W., Suite 400, WASHINGTON, DC, 20005, US

(73) Assignees: Pioneer Corporation, Tokyo (JP); Pioneer System Technology Corporation, Sendai-shi (JP); Techexperts Incorporation, Tokyo (JP)

(21) Appl. No.: 11/661,804

(22) PCT Filed: Aug. 31, 2005
(86) PCT No.: PCT/JP05/15850

§ 371 Date: Feb. 12, 2008

(30) Foreign Application Priority Data
Sep. 1, 2004 (JP) 2004-254460
Dec. 16, 2004 (JP) 2004-364989

(51) Int. Cl. G10L 17/00

(52) U.S. Cl. 704/246

(57) ABSTRACT

A processor 300 of a navigation device 200 operates a response voice analyzer of a process status setting unit to acquire a destination-responding voice collected by a microphone 230. Then, the processor 300 operates the state setting controller of the process state setting unit to identify a user of a vehicle based on the destination-responding voice and to set a navigation processor and a music reproducing unit so as to perform processes in accordance with the identified user.

### TECHNICAL FIELD

The present invention relates to a process control device for supporting a travel of a mobile body, its method, its program and a recording medium containing the program.

### BACKGROUND ART

There has been conventionally known a music reproducing device that is installed in a vehicle as a mobile body and reproduces music (see, for instance, Patent Document 1).

Patent Document 1 discloses an arrangement in which, when an operation for presetting music that is contained in a CD (Compact Disc) loaded on a CD drive of a CD changer is recognized during reproduction of the music, music data of a beginning part of the music is read out from the CD drive. The beginning part of the read music data, a disc number, a track number and a music name of this music are stored in a preset memory that allows quick reproduction of music data as compared to the CD changer. Thereafter, when the operation for selecting the preset music is recognized, the beginning part of the music data the stored in the preset memory is retrieved and reproduced. During the reproduction of the beginning part from the preset memory, the music data of the corresponding music is retrieved from the CD drive, and the music data read out from the CD drive is reproduced instead of from the preset memory.

[Patent Document 1] JP-A-2004-95015 (pages 3 to 6)

### DISCLOSURE OF THE INVENTION

### Problems to be Solved by the Invention

However, in the arrangement disclosed in Patent Document 1, especially when such a music reproducing device is installed in a vehicle, an operation for selecting a desired music that has been preset is bothersome for a user who is driving the vehicle.

An object of the present invention is to provide a process control device, its method, its program and a recording medium containing the program that can solve such a problem.

### Means for Solving the Problems

According to an invention of claim 1, a process control device includes: a usage state information acquirer that acquires usage state information about a usage state of a mobile body using a travel support function that supports a travel of the mobile body; a user identification section that identifies a user of the mobile body based on the usage state of the usage state information; a music selection processor that performs a music selection for selecting predetermined music; and a music selection process controller that controls the music selection processor to perform the music selection in accordance with the identified user.

According to an invention of claim 2, a process control device includes: a usage state information acquirer that acquires usage state information about a usage state of a mobile body using a travel support function that supports a travel of the mobile body; a user identification section that identifies a user of the mobile body based on the usage state of the usage state information; a music output processor that performs a music output for outputting predetermined music; and a music output process controller that controls the music output processor to output the music using an output form according to the identified user.

According to an invention of claim 3, a process control device includes: a usage state information acquirer that acquires usage state information about a usage state of a mobile body using a travel support function that supports a travel of the mobile body; a user identification section that identifies a user of the mobile body based on the usage state of the usage state information; an information selection processor that performs information selection for selecting predetermined information to be output in use of the mobile body; and an information selection process controller that controls the information selection processor to perform the information selection in accordance with the identified user.

According to an invention of claim 4, a process control device includes: a usage state information acquirer that acquires usage state information about a usage state of a mobile body using a travel support function that supports a travel of the mobile body; a user identification section that identifies a user of the mobile body based on the usage state of the usage state information; an information output processor that performs information output for outputting predetermined information to be output in use of the mobile body; and an information output process controller that controls the information output processor to output the information using an output form according to the identified user.

According to an invention of claim 5, a process control device includes: a characteristic information acquirer that acquires characteristic information about a characteristic of a user; a user identification section that identifies the user based on the characteristic of the characteristic information; an information selection processor that performs an information selection for selecting predetermined information; and an information selection process controller that controls the information selection processor to perform the information selection in accordance with the identified user.

According to an invention of claim 7, a process control device includes: a characteristic information acquirer that acquires characteristic information about a characteristic of a user; a user identification section that identifies the user based on the characteristic of the characteristic information; an information output processor that performs an information output for outputting predetermined information; and an information output process controller that controls the information output processor to output the information using an output form according to the identified user.

According to an invention of claim 17, a process control device includes: a characteristic information acquirer that acquires characteristic information about a characteristic of a user of a mobile body; a user identification section that identifies the user based on the characteristic of the characteristic information; a travel support process performing section that performs a travel support for supporting a travel of the mobile body; and a travel support process controller that controls the travel support performing section to perform the travel support using a setting condition according to the identified user.

According to an invention of claim 23, a process control device includes: a usage state information acquirer that acquires usage state information about a usage state of a mobile body using a function that performs a travel support for supporting a travel of the mobile body; a user identification section that identifies a user of the mobile body based on the usage state of the usage state information; a travel support process performing section that performs the travel support; and a travel support process controller that controls the travel support performing section to perform the travel support using a setting condition according to the identified user.

According to an invention of claim 34, a process control method for controlling a music selection for selecting predetermined music includes: acquiring usage state information about a usage state of a mobile body using a travel support function that supports a travel of the mobile body; identifying a user of the mobile body based on the usage state of the usage state information; and performing the music selection in accordance with the identified user.

According to an invention of claim 35, a process control method for controlling a music output for outputting predetermined music includes: acquiring usage state information about a usage state of a mobile body using a travel support function that supports a travel of the mobile body; identifying a user of the mobile body based on the usage state of the usage state information; and outputting the music using an output form according to the identified user.

According to an invention of claim 36, a process control method for controlling information selection for selecting predetermined information to be output in use of a mobile body includes: acquiring usage state information about a usage state of the mobile body using a travel support function that supports a travel of the mobile body; identifying a user of the mobile body based on the usage state of the usage state information; and performing the information selection in accordance with the identified user.

According to an invention of claim 37, a process control method for controlling an information output for outputting predetermined information to be output in use of a mobile body includes: acquiring usage state information about a usage state of the mobile body using a travel support function that supports a travel of the mobile body; identifying a user of the mobile body based on the usage state of the usage state information; and outputting the information using an output form according to the identified user.

According to an invention of claim 38, a process control method for controlling an information selection for selecting predetermined information includes: acquiring characteristic information about a characteristic of a user; identifying the user based on a characteristic of the characteristic information; and performing the information selection in accordance with the identified user.

According to an invention of claim 39, a process control method for controlling an information output for outputting predetermined information includes: acquiring characteristic information about a characteristic of a user; identifying the user based on the characteristic of the characteristic information; and outputting the information using an output form according to the identified user.

According to an invention of claim 40, a process control method for controlling a travel support for supporting a travel of a mobile body includes: acquiring characteristic information about a characteristic of a user of the mobile body; identifying a user based on the characteristic of the characteristic information; and performing the travel support using a setting condition according to the identified user.

According to an invention of claim 41, a process control method for controlling a travel support for supporting a travel of a mobile body includes: acquiring usage state information about a usage state of a mobile body using a function that performs the travel support; identifying a user of the mobile body based on the usage state of the usage state information; and performing the travel support using a setting condition according to the identified user.

According to an invention of claim 42, a process control program operates a computing section as the process control device according to any one of claims 1 to 33.

According to an invention of claim 43, a process control program operates a computing section to perform the process control method according to any one of claims 34 to 41.

According to an invention of claim 44, a recording medium stores the process control program according to claim 42 or 43 in a manner readable by a computing section.

### BRIEF DESCRIPTION OF DRAWINGS

FIG. 1 is a block diagram briefly showing an arrangement of a navigation system according to a first embodiment of the present invention;

FIG. 2 is a schematic illustration briefly showing an arrangement of user-specific setting list information according to the first embodiment;

FIG. 3 is a block diagram briefly showing an arrangement of a processor of a navigation device according to the first embodiment;

FIG. 4 is a flowchart showing a process state setting according to the first embodiment;

FIG. 5 is another flowchart showing the process state setting according to the first embodiment;

FIG. 6 is a block diagram briefly showing an arrangement of a navigation system according to a second embodiment of the present invention;

FIG. 7 is a schematic illustration briefly showing an arrangement of user-specific setting list information according to the second embodiment;

FIG. 8 is a block diagram briefly showing an arrangement of a processor of a navigation device according to the second embodiment;

FIG. 9 is a flowchart showing a process state setting according to the second embodiment;

FIG. 10 is a flowchart showing an image analysis according to the second embodiment; and

FIG. 11 is a flowchart showing a voice analysis according to the second embodiment.

### EXPLANATION OF CODES

200, 700: navigation device as process control device
260: voice output unit also functioning as travel route notifier
290, 730: memory as state-specific process information storage section
311: response voice analyzer also functioning as usage state information acquirer
312: registration judging section also functioning as music selection process controller, music output process controller and travel support process controller
313: state setting controller as music selection process controller, music output process controller and travel support process controller that also function as user identification section
314, 816: setting information generator as state-specific process information generator
320: navigation processor as travel support process performing section
321: current position recognizer as current position information acquirer
322: destination recognizer as destination information acquirer
323: route processor as travel route setting section that also functions as map information acquirer
324: guidance notifier as route notification processor
331: music selecting section as music selection processor that can also function as information selection processor and content selection processor
332: music reproduction processor as music output processor that can also function as information output processor and content reproduction processor
510, 910: user-specific setting information as state-specific process information
511: registration voice quality information as usage state detail information
512: registration destination information as usage state detail information
514A: route condition information as travel support process information
514B: notification form information as travel support process information
514C: selected music information as music selection process information
812: voice registration judging section also functioning as information selection process controller, information output process controller, content selection process controller, content output process controller, music selection process controller, music output process controller, image selection process controller, image output process controller and travel support process controller
813: captured image analyzer as characteristic information acquirer
814: image registration judging section also functioning as information selection process controller, information output process controller, content selection process controller, content output process controller, music selection process controller, music output process controller, image selection process controller, image output process controller and travel support process controller
815: state setting controller as information selection process controller, information output process controller, content selection process controller, content output process controller, music selection process controller, music output process controller, image selection process controller, image output process controller and travel support process controller that also function as user identifying information
820: navigation processor as travel support process performing section
824: guidance notifier being route notification processor as information output processor
851: content selecting section as information selection processor, content selection processor and image selection processor
852: content reproduction processor as information output processor, content output processor and image display processor

### BEST MODE FOR CARRYING OUT THE INVENTION

### First Embodiment

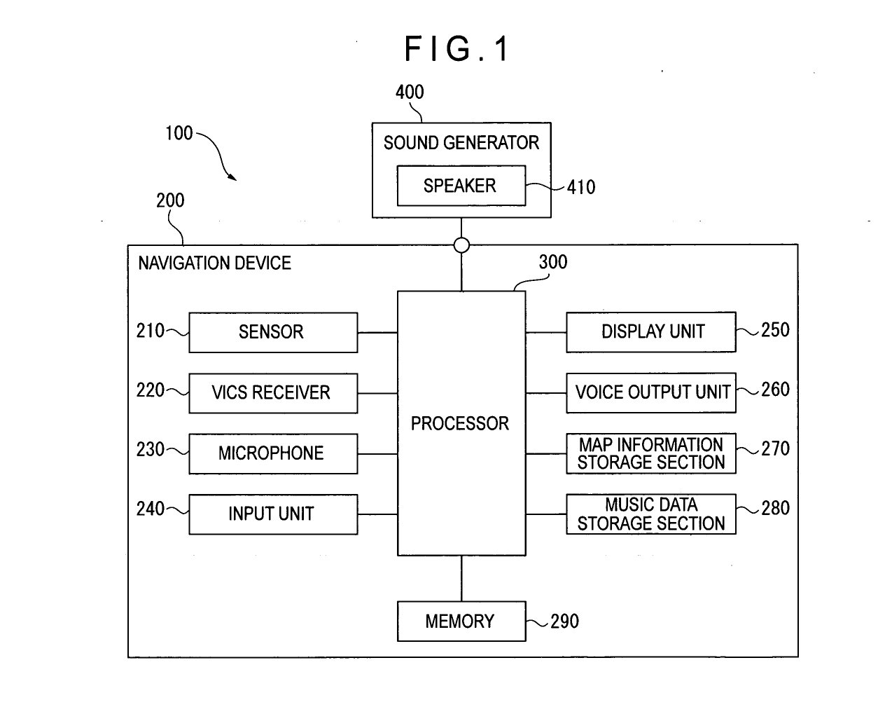

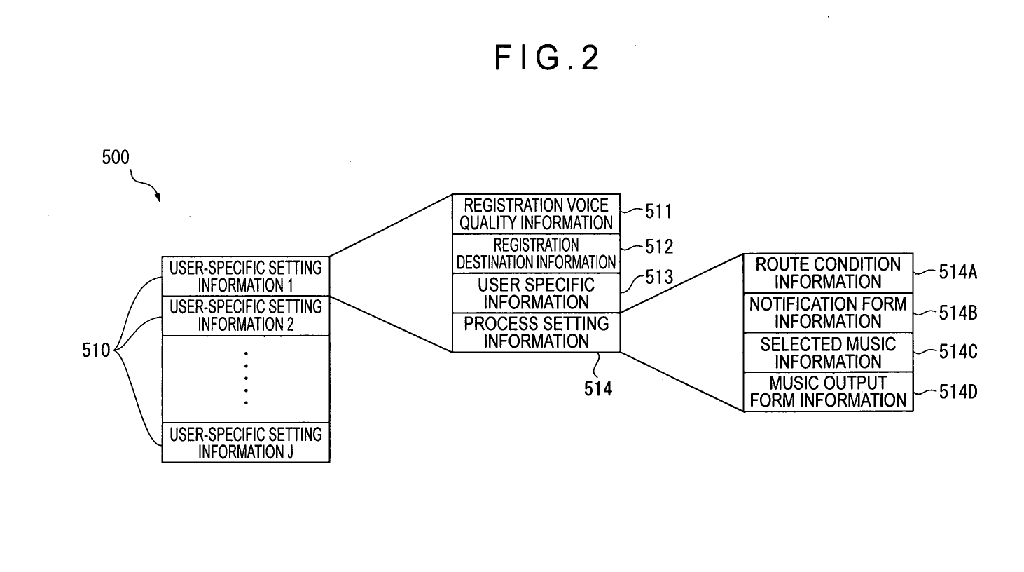

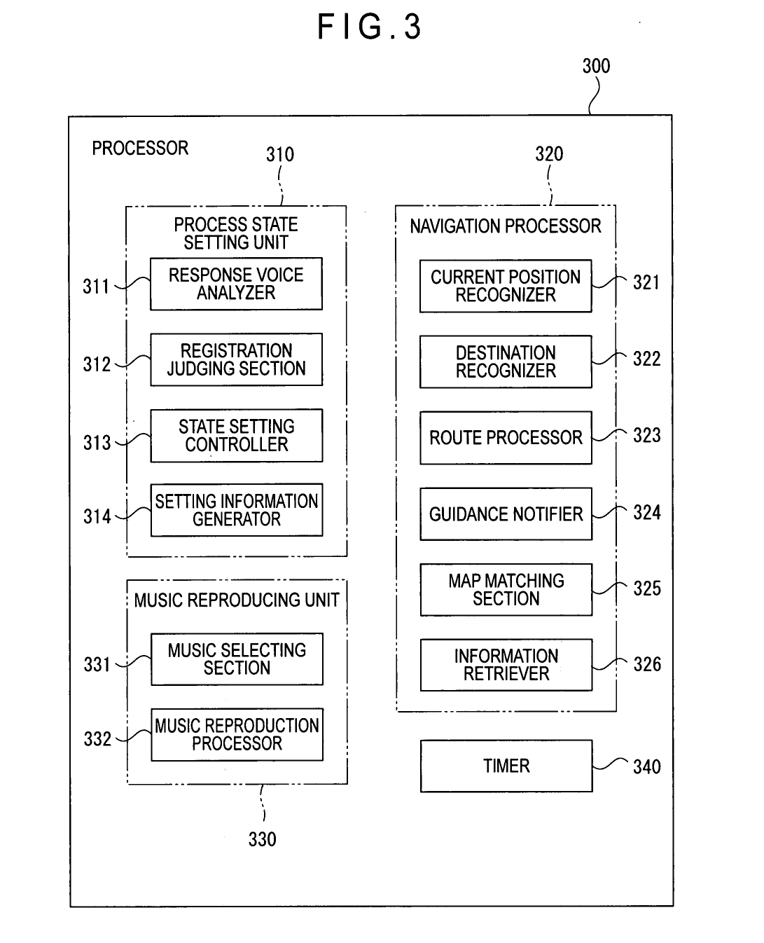

Now, a first embodiment of the present invention will be described with reference to the attached drawings. The first embodiment will be described by taking as an example a navigation system that includes a navigation device as a process control device of the present invention, the navigation system having an arrangement for supporting a travel of a mobile body (e.g., vehicle) as navigation and an arrangement for selecting and reproducing music. It should be noted that the navigation system of the present invention is not necessarily designed to support a vehicle for the driving thereof, but may be so designed to support a travel of any type of mobile body. FIG. 1 is a block diagram briefly showing an arrangement of a navigation system. FIG. 2 is a schematic illustration briefly showing an arrangement of user-specific setting list information. FIG. 3 is a block diagram briefly showing an arrangement of a processor of the navigation device.

[Arrangement of Navigation System]

Referring to FIG. 1, the reference numeral 100 denotes the navigation system. The navigation system 100 notifies guidance on a travel along with a travel progress of a mobile body (e.g. vehicle) and reproduces music. The navigation system 100 appropriately sets a process state of each process in accordance with a user of the vehicle, namely a driver or a fellow passenger. Specifically, the navigation system 100 sets states such as setting a narrow road as a travel route and increasing the number of notification of the travel route in accordance with the user. In addition, the navigation system 100 selects music to be reproduced or sets an output form of sound in accordance with the user. Note that the setting or the notification of a travel route according to the user and selection or output of music according to the user correspond to a travel support Further, a navigation function and a voice output function such as “Where are you going?” in the navigation system 100 and a wheel, a brake, an indicator and the like of the vehicle correspond to a travel support function. The navigation system 100 includes a navigation device 200, a sound generator (music output section) 400 and the like.

The sound generator 400 includes speakers 410 that are respectively disposed on right and left sides of a front or rear part of an inner space of the vehicle, for instance, in an instrument panel, doors and a rear dashboard. The sound generator 400, under the control of the navigation device 200, outputs from the speakers 410 music data or the like that is output as a speaker signal from the navigation device 200.

The navigation device 200 may be, for example, an in-vehicle unit installed in a vehicle as a portable body, a portable unit, a PDA (Personal Digital Assistant), a mobile phone, a PHS (Personal Handyphone System) or a portable personal computer. The navigation device 200 searches for a route to a destination or retrieves a certain shop nearby based on map information stored in the navigation device 200. In addition, the navigation device 200 notifies various information about the searched route or the retrieved shop, information about a current position or the destination, etc. Further, the navigation device 200 reproduces music based on music data stored in the navigation device 200 or music data recorded in a CD (Compact Disc) or an MD (Mini Disc). The navigation device 200 includes a sensor 210, a VICS (Vehicle Information Communication System) receiver 220, a microphone 230, an input unit 240, a display unit 250, a voice output unit 260 also functioning as a travel route notifier, a map information storage section 270, a music data storage section 280, a memory 290 as a state-specific process information storage section, a processor 300 and the like.

The sensor 210 senses the travel progress of a mobile body (e.g. a vehicle), or the current position and the driving status, which is output as a sensor signal to the processor 300. The sensor 210 typically has a GPS (Global Positioning System) receiver (not shown) and various sensors such as a speed sensor, an azimuth sensor and an acceleration sensor (each not shown).

The GPS receiver receives electric navigation waves output from a GPS satellite (not shown), which is an artificial satellite, via a GPS antenna (not shown). Then, the GPS receiver computes simulated coordinate values of the current position based on a signal corresponding to the received electric navigation waves and outputs the simulated coordinate values as GPS data to the processor 300.

The speed sensor of the sensor 210 is arranged on the mobile body (e.g. a vehicle) so as to detect driving speed and actual acceleration of the vehicle based on a signal that varies depending on driving speed of the vehicle. The speed sensor reads a pulse signal, a voltage value and the like output in response to the revolution of axles and wheels of the vehicle, and outputs speed detection information such as the read pulse signal and voltage value to the processor 300. The azimuth sensor is arranged on the vehicle and provided with a so-called gyro-sensor (not shown) so as to detect the azimuth of the vehicle, i.e., a driving direction for which the vehicle is heading. The azimuth sensor outputs driving direction information about the detected driving direction to the processor 300. The acceleration sensor is arranged on the vehicle so as to detect the acceleration of the vehicle in the driving direction thereof. The acceleration sensor converts the detected acceleration into a sensor output value, which is for instance the pulse and the voltage, and then outputs the sensor output value to the processor 300.

The VICS receiver 220 has a VICS antenna (not shown) and acquires information about the traffic via the VICS antenna. More specifically, the VICS receiver 220 acquires traffic information (hereinafter referred to as VICS data) about traffic jams, traffic accidents, constructions, traffic controls and so on from the VICS (not shown) by way of a beacon, FM multiplex broadcasting or the like. The acquired information about traffic is output as a VICS signal to the processor 300.

The microphone 230 is arranged on, for instance, a front surface of a casing (not shown) of the navigation device 200. The microphone 230 acquires or collects a voice of a user for responding to a destination-asking voice such as “Where are you going” or a user-asking voice such as “Who are you?”, the asking voices each output from the voice output unit 260 under the control of the processor 300. It should be noted that, in the following description, the voice for responding to the destination-asking voice will be referred to as a destination-responding voice and the voice for responding to the user-asking voice will be referred to as a user-responding voice. The microphone 230 outputs to the processor 300 response voice information about the collected destination-responding voice or user-responding voice. Here, the response voice information about the destination-responding voice serves as usage state information of the present invention. A state how the user who makes the destination-responding voice uses the vehicle corresponds to a usage state of a mobile body of the present invention. A voice quality of the destination-responding voice corresponds to a feature of voice as a biological characteristic of the present invention. A condition how the vehicle travels to the destination indicated by the destination-responding voice corresponds to a travel status of a mobile body as a usage state of a mobile body of the present invention.

The input unit 240 has various operation buttons and operation knobs (each not shown) to be used for input operations, the operation buttons and knobs arranged on, for instance the front surface of the casing. The operation buttons and the operation knobs are used to input, for example, the settings for the operations of the navigation device 200. More specifically, the operation buttons and the operation knobs may be used: to set details of information to be acquired and acquiring criteria; to set a destination; to retrieve information; to make a setting for displaying the driving status (travel progress) of the vehicle; to select music to be reproduced; to set a sound volume and a sound field; and to make a setting for generating user-specific setting information 510 (described later). When the settings are input, the input unit 240 outputs various information as operation signals to the processor 300 so as to apply the settings. In place of the input operation using the operation buttons and the operation knobs, the input unit 240 may employ any input operation capable of inputting various settings, such as an input operation using a touch panel arranged on the display unit 250 and an input operation with a voice. In addition, the input unit 240 may receive various information transmitted from a remote controller (not shown) through infrared rays and output the various information as operation signals to the processor 300 so as to apply the settings.

The display unit 250 displays image data transmitted as an image signal from the processor 300. Examples of information displayed by the display unit 250 may include map information, retrieval information, information about music, information about reproduction state of the music and various information used in generating user-specific setting information 510. The display unit 250 may typically be a liquid-crystal display panel, an organic EL (Electro Luminescence) panel, a PDP (Plasma Display Panel), a CRT (Cathode-Ray Tube), an FED (Field Emission Display), or an electrophoretic display panel. The display unit 250 can also output TV image data received by a TV receiver or the like.

The voice output unit 260 has, for instance, a speaker (not shown). The voice output unit 260 outputs voice data as a voice from the speaker, the voice data transmitted as a voice signal from the processor 300. Information output as the voice may be various information for navigating the vehicle such as the driving direction and the driving status of the vehicle and traffic condition and various information used in generating the user-specific setting information 510. The speaker can also output TV voice data received by a TV receiver (not shown) or the like. In place of the speaker provided to the voice output unit 260, the voice output unit 260 may use the speakers 410 of the sound generator 400.

The map information storage section 270 readably stores the map information, retrieval information used for acquiring information of a predetermined point in the map information, and the like. The map information storage section 270 may include drives or drivers for readably storing data on a recording medium such as a magnetic disk like an HD (Hard Disk), an optical disc like a CD or a DVD (Digital Versatile Disc) and a memory card.

The map information includes display data as POI (Point Of Interest), matching data and a travel route search map data.

The display data includes, for example, plural pieces of display mesh information, each having a unique number. Specifically, the display data is divided into plural pieces of display mesh information, each relating to an area. The display data is constituted from the plural pieces of display mesh information continuously arranged in a matrix form. The display mesh information includes name information for displaying names of intersections or the like, road information for displaying roads and background information for displaying buildings or the like.

The matching data, just like the display data, is divided into plural pieces of matching mesh information, each having a unique number and relating to an area. The matching data is constituted from the plural pieces of matching mesh information continuously arranged in a matrix form. The matching data is used for map matching process for correcting the displayed information to locate a mark representing the vehicle on a road, when the travel progress of the vehicle is superposed on the map information. This process prevents such errors in which the mark representing the vehicle is displayed on a building instead of the road. The matching data is associated with VICS data to match the positional relationship between the VICS data and the displayed map.

The travel route search map information is structured in a table having point information indicating a point and segment information connecting the points, the travel route search map information having an information structure for displaying roads for a travel route search.

The music data storage section 280 readably stores music list data. The music data storage section 280 may include, similarly to the map information storage section 270, drives or drivers for readably storing data on a recording medium such as an HD (Hard Disk), an optical disc like a CD or a DVD and a memory card.

The music list data is data about a list of music to be reproduced. The music list data is structured such that at least one piece of music individual data is associated as a single data structure.

The music individual data is information about a single piece of music. The music individual data is structured in a table in which music data, music related information and the like are associated as a single data structure. The music individual data may contain only the music data. The music data is data used in reproducing music. The music data contains music in a reproducible manner, the musing being of MIDI (Musical Instrument Digital Interface) format, WAVE format or MPEG (Moving Picture Experts Group) format. The music related information is information about music to be reproduced by the music data. Specifically, the music related information is structured in a table in which music name information containing information about a music name as data, player information containing information about a player as data, a reproduction time information containing information about a reproduction time of the music as data and the like are associated as a singe data structure.

The memory 290 readably stores the settings input at the input unit 240, various information such as the user-specific setting list information 500 shown in FIG. 2 which is acquired or generated by the processor 300, a voice quality flag S and a destination flag P used in a process state setting for setting a process state according to a user, voice data, image data and the like. The memory 290 also stores various programs that run on the OS (Operating System) controlling the whole operation of the navigation device 200. The memory 290 may preferably be a CMOS (Complementary Metal-Oxide Semiconductor) memory that retains the stored data even in the case of, for instance, a sudden power interruption caused by a blackout. The memory 290 may include drives or drivers for readably storing data on a recording medium such as an HD, a DVD, and an optical disc.

The user-specific setting list information 500 is information about a list of settings of process states according to one user or each of a plurality of users. The user-specific setting list information 500 is structured such that at least one piece of user-specific setting information 510 as state-specific process information is associated as a single data structure.

The user-specific setting information 510 is information about a setting of a process state according to a user. The user-specific setting information 510 is properly generated or deleted by the processor 300. The user-specific setting information 510 is structured such that registration voice quality information 511 as usage state detail information, registration destination information 512 as usage state detail information, user specific information 513, process setting information 514 and the like are associated as a single data structure.

The registration voice quality information 511 is information about a voice quality of a destination-responding voice (hereinafter referred to as a response voice quality) of at least one user, the destination-responding voice collected by the microphone 230. The registration destination information 512 is information about at least one destination, which is a particular spot, shop or station on a predetermined day of the week or at a predetermined time (hereinafter, referred to as a predetermined time), the information being formed as data. For example, the registration destination information 512 is information indicating that a destination around 7:00 am from Monday to Friday is an office or information indicating that a destination around 10:00 on Saturday is a shopping mall. Note that the registration destination information 512 may only indicate a destination. The user-specific setting information 510 may contain, instead of registration destination information 512, information about a current position of the vehicle or a stop-by spot. The user specific information 513 is information in which information specific to at least one user such as a name of the user or a relationship like “Father” or “Mother” is formed as data. The process setting information 514 is information about the process state that is set in accordance with the user contained in the user specific information 513. The process setting information 514 is structured such that route condition information 514A as travel support process information, notification form information 514B as travel support process information, selected music information 514C as music selection process information, music output form information 514D and the like are associated as a single data structure.

The route condition information 514A is information about a setting condition of a travel route that is set in accordance with the user. The setting condition that is set by the route condition information 514A may include whether or not a narrow road is set as the travel route, whether or not a travel route with a short required time or short travel distance is set and whether or not a toll road is selected with higher priority. The notification form information 514B is information about a notification form of the travel route that is set in accordance with the user. The notification form set by the notification form information 514B may include whether or not the map is displayed in a manner corresponding to the traveling direction, and a setting of a timing or the number of times of the notification. The selected music information 514C is information for identifying music to be selected in accordance with the user, e.g., information about a name or a player of music. The music output form information 514D is information about an output form of sound in reproduction of music, which is set in accordance with the user. Here, the output form of the sound set by the music output form information 514D may include an output level of high-pitched sound and low-pitched sound, auditory lateralization, an output balance of the speakers 410, a setting of so-called delay in which sound that is delayed in time is added to obtain rich sound and an output form suitable for music of a particular genre such as rock and jazz.

It should be noted that the process setting information 514 contains the above-described information 514A to 514D is exemplified, but the process setting information 514 may contain at least one of the information 514A to 514D. Further, various conditions or forms set by the information 514A to 514D are not limited to those described above but may include other suitable conditions and forms.

The voice quality flag S indicates whether or not registration voice quality information 511 corresponding to the response voice quality of the destination-responding voice collected by the microphone 230 is contained in the user-specific setting list information 500, namely whether or not the corresponding voice quality is registered or not The voice quality flag S being “0” indicates the registration voice quality information 511 corresponding to the response voice quality is not registered, while the voice quality flag S being “1” indicates the corresponding registration voice quality information 511 is registered. The destination flag P indicates whether or not registration destination information 512 corresponding to a destination specified by the destination-responding voice (hereinafter, referred to as a responded destination) is registered in the user-specific setting list information 500. The destination flag P being “0” indicates the registration destination information 512 corresponding to the responded destination is not registered, while the destination flag P being “1” indicates the corresponding registration destination information 512 is registered.

The processor 300 has various input/output ports (not shown) including a GPS receiving port connected to a GPS receiver, sensor ports respectively connected to various sensors, a VICS receiving port connected to a VICS antenna, a microphone port connected to the microphone 230, a key input port connected to the input unit 240, a display port connected to the display unit 250, a voice port connected to the voice output unit 260, a map storage port connected to the map information storage section 270, a music data storage port connected to the music data storage section 280, a memory port connected to the memory 290 and a sound-generating port connected to the sound generator 400. As shown in FIG. 3, the processor 300 has various programs such as a process state setting unit (computing section) 310, a navigation processor (travel support process performing section) 320, a music reproducing unit (travel support process performing section) 330 as a music process performing section, a timer 340 and the like.

The process state setting unit 310 sets the process states of the navigation processor 320 and the music reproducing unit 330 to states according to the user. The process state setting unit 310 includes a response voice analyzer 311 that also functions as a usage state information acquirer, a registration judging section 312 that also functions as a music selection process controller, a music output process controller and a travel support process controller, a state setting controller 313 as a music selection process controller, a music output process controller and a travel support process controller that also function as a user identification section, a setting information generator 314 as a state-specific process information generator and the like. Note that the response voice analyzer 311, the registration judging section 312, the state setting controller 313 and the setting information generator 314 form a travel support control device. The response voice analyzer 311, the registration judging section 312, the state setting controller 313, the setting information generator 314, the navigation processor 320 and the music reproducing unit 330 form a travel support device. Herein, the travel support control device may not include the setting information generator 314. The travel support device may not include one of the navigation processor 320 and the music reproducing unit 330.

The response voice analyzer 311 analyzes the destination-responding voice collected by the microphone 230 to recognize the response voice quality and the responded destination. Specifically, when recognizing that the navigation device 200 is turned on, the response voice analyzer 311 controls the voice output unit 260 to output the destination-asking voice such as “Where are you going?” as described above. The response voice analyzer 311 may be so arranged to output the destination-asking voice when it recognizes opening/closing of a door for a driver change or the like. The response voice analyzer 311 operates the microphone 230 to collect the destination response voice and to output the response voice information. Then, when acquiring the destination-responding voice of the response voice information, the response voice analyzer 311 recognizes the response voice quality and the responded destination based on, for instance, a speech wave form or a spectral envelope obtained by frequency analysis of the destination-responding voice. When a plurality of users makes destination-responding voices, the response voice analyzer 311 recognizes a response voice quality of each user. Also, the response voice analyzer 311 acquires current time/date information (described later) about a current time and date from the timer 340. The current time/date information acquired by the response voice analyzer 311 serves as usage state information of the present invention. The response voice analyzer 311 generates response voice quality recognition information about the recognized response voice quality and stores the response voice quality recognition information in the memory 290. The response voice analyzer 311 then generates a responded destination recognition information in which the recognized responded destination is associated with a time or a day of the week contained in the current time/date information as a predetermined time and stores the responded destination recognition information in the memory 290.

The response voice analyzer 311 also analyzes the user-responding voice collected by the microphone 230 to recognize a name or a relationship of a user specified by the user-responding voice (hereinafter, referred to as a responded user name). Specifically, the response voice analyzer 311, under the control of the setting information generator 314, outputs the user-asking voice such as “Who are you?” as described above and operates the microphone 230 to collect the user-responding voice and to output the response voice information. When acquiring the user response voice of the response voice information, the response voice analyzer 311 recognizes the responded user name specified by the user-responding voice. The response voice analyzer 311 generates responded user name recognition information about the recognized responded user name and stores the responded user name recognition information in the memory 290.

The registration judging section 312 judges whether or the registration voice quality information 511 and the registration destination information 512 corresponding to the destination-responding voice is registered in the user-specific setting list information 500. Specifically, the registration judging section 312 acquires the response voice quality recognition information from the memory 290 and retrieves the registration voice quality information 511 corresponding to the response quality voice of the response voice quality recognition information from the user-specific setting list information 500. When the corresponding registration voice quality information 511 can be retrieved, namely when registration of the corresponding registration voice quality information 511 is recognized, the registration judging section 312 sets the voice quality flag S of the memory 290 to “1”. On the other hand, when recognizing that the corresponding registration voice quality information 511 is not registered, the registration judging section 312 sets the voice quality flag S to “0”. Then, the registration judging section 312 acquires the responded destination recognition information from the memory 290 and retrieves the registration destination information 512 corresponding to the responded destination associated with the predetermined time contained in the responded destination recognition information from the user-specific setting list information 500. When recognizing the corresponding registration destination information 512 is registered, the registration judging section 312 sets the destination flag P of the memory 290 to “1”, while when recognizing the corresponding registration destination information 512 is not registered, the registration judging section 312 sets the destination flag P to “0”.

The state setting controller 313 performs a control to appropriately set the navigation processor 320 and the music reproducing unit 330 so as to perform processes in accordance with the user of the vehicle based on the various judgments of the registration judging section 312. Specifically, the state setting controller 313 acquires the voice quality flag S and the destination flag P of the memory 290. When recognizing that both of the settings of the voice quality flag S and the destination flag P are “1”, the state setting controller 313 judges that the user can be identified based on the destination-responding voice. Then, the state setting controller 313 acquires the user-specific setting information 510 based on the destination-responding voice from the memory 290. For example, the state setting controller 313 retrieves and acquires from the memory 290 the user-specific setting information 510 that contains the registration voice quality information 511 and the registration destination information 512 retrieved by the registration judging section 312. The state setting controller 313 controls the voice output unit 260 to output an identification completion voice for notifying that the user has been identified, such as “You are Taro. Settings are provided according to your preference.”, based on the user specific information 513 of the user-specific setting information 510. The state setting controller 313 then outputs the route condition information 514A and the notification form information 514B contained in the process setting information 514 of this user-specific setting information 510 to the navigation processor 320 and outputs the music output form information 514D and the selected music information 514C to the music reproducing unit 330. Specifically, the state setting controller 313 performs a control such that the navigation processor 320 and the music reproducing unit 330 perform processes according to the user based on the process setting information 514.

When recognizing that both of the settings of the voice quality flag S and the destination flag P are “0”, the state setting controller 313 judges that the user-specific setting information 510 of the user corresponding to the destination-responding voice is not registered in the user-specific setting list information 500. In this case, the state setting controller 313 controls the voice output unit 260 to output a new registration guidance voice for notifying that user-specific setting information 510 is newly generated, such as “You are newly registered”. Also, the state setting controller 313 controls the setting information generator 314 to generate the user-specific setting information 510 corresponding to the user of the destination-responding voice and register the generated user-specific setting information 510 in the user-specific setting list information 500. Then, the state setting controller 313 performs a control such that the navigation processor 320 and the music reproducing unit 330 perform processes according to the user based on the user-specific setting information 510 registered by the setting information generator 314.

When recognizing that the setting of one of the voice quality flag S and the destination flag P is “0” while the setting of the other is “1”, the state setting controller 313 judges that the user cannot be identified based on the destination-responding voice. In this case, the state setting controller 313 controls the display unit 250 to display a list of details of the user-specific setting information 510 stored in the memory 290 and controls the voice output unit 260 to output a manual setting guidance voice for requesting manual setting of a process state, such as “Please manually input a setting”. Then, when acquiring an operation signal for selecting one piece of the displayed user-specific setting information 510 through the input operation at the input unit 240, the state setting controller 313 acquires the selected user-specific setting information 510 from the memory 290. Specifically, the state setting controller 313 acquires the user-specific setting information 510 based on the manual setting of the user. Then, the state setting controller 313 performs a control such that the navigation processor 320 and the music reproducing unit 330 perform processes according to the user based on the acquired user-specific setting information 510.

The setting information generator 314 appropriately generates the user-specific setting information 510 to store the generated user-specific setting information 510 in the memory 290, namely registers the user-specific setting information 510 in the user-specific setting list information 500. Specifically, the setting information generator 314 controls the display unit 250 to display a list of details of music related information of the music individual data stored in the music data storage section 280. Then, when acquiring an operation signal for selecting at least one piece of the displayed music related information through the input operation at the input unit 240, the setting information generator 314 generates selected music information 514C containing a name or a player of the music of the selected music related information. The setting information generator 314 controls the display unit 250 to display indication for requesting setting of an output form of sound, a setting condition of the travel route and a notification form of the travel route. When acquiring an operation signal for setting the forms and the conditions through the input operation at the input unit 240, the setting information generator 314 generates music output form information 514D, the route condition information 514A and the notification form information 514B respectively containing the set forms and conditions. Then, the setting information generator 314 generates process setting information 514 containing the generated information 514A to 514D.

The setting information generator 314 operates the response voice analyzer 311 to generate the responded user name recognition information and acquires this responded user name recognition information, the response voice quality recognition information and the responded destination recognition information from the memory 290. The setting information generator 314 generates the registration voice quality information 511 containing the response voice quality of the response voice quality recognition information, the registration destination information 512 containing the responded destination associated with the predetermined time of the responded destination recognition information and the user specific information 513 containing the responded user name of the responded user name recognition information. It should be noted that although the arrangement in which the registration destination information 512 contains the predetermined time and the responded destination of the responded destination recognition information, the registration destination information 512 may contain a predetermined time and a destination that are newly set by a user. The setting information generator 314 generates the user-specific setting information 510 containing the generated information 511 to 514 and registers the generated user-specific setting information 510 in the user-specific setting list information 500.

The navigation processor 320 generates various information about the travel of the vehicle. The navigation processor 320 includes a current position recognizer (current position information acquirer) 321, a destination recognizer (destination information acquirer) 322, a route processor (travel route setting section) 323 that also functions as a map information acquirer, a guidance notifier (route notification processor) 324, a map matching section 325, an information retriever 326 and the like.

The current-position recognizer 321 recognizes the current position of the vehicle. Specifically, the current-position recognizer 321 calculates the current position of the vehicle in the map information that has been separately acquired based on the various data output from the speed sensor and the azimuth sensor of the sensor 210 and the GPS data about the current position output from the GPS receiver, and recognizes the current position information. The current-position recognizer 321 can recognize not only the current position of the vehicle as described above but also a departure point, i.e. an initial point set by the input unit 240 as the current simulated position. Current position information about the current position or the current simulated position acquired by the current-position recognizer 321 is appropriately stored in the memory 290.

The destination recognizer 322 typically acquires the destination information about the destination set by the input operation at the input unit 240 and recognizes the position of the destination. The destination information to be set includes various information for identifying a spot, which might be coordinates such as latitude and longitude, addresses, telephone numbers and the like. Such destination information recognized by the destination recognizer 322 is appropriately stored in the memory 290.

The route processor 323 searches for a route by computing a travel route of the vehicle using the setting condition according to the user based on the VICS data acquired by the VICS receiver 220 and the map information stored in the map information storage section 270. Specifically, the route processor 323 acquires the route condition information 514A and the notification form information 514B from the process state setting unit 310. The route processor 323 also acquires the current position information, the destination information and the VICS data. Then, the route processor 323 sets a travel route using the setting condition according to the user based on the route condition information 514A on the basis of these various information and the travel route search map information of the map information, specifically the travel route being set by reflecting whether or not a narrow road is set as the travel route, whether or not a travel route with a short required time or short travel distance is set, whether or not a toll road is selected with higher priority and the like.

The travel route information typically includes route guidance information for navigating the vehicle during the drive thereof for assisting the drive. Under the control of the guidance notifier 324, the route guidance information may be appropriately displayed on the display unit 250 or output as a voice from the voice output unit 260 to assist the drive. The route processor 323 generates route guidance information by reflecting the notification form according to the user based on the notification form information 514B of the process state setting unit 310, specifically whether the number of types of guidance is set to large or small and the like. When acquiring setting information about a predetermined setting condition of a travel route input at the input unit 240, the route processor 323 sets a travel route by reflecting the predetermined setting condition of the setting information. The travel route information generated by the route processor 323 is appropriately stored in the memory 290.

The guidance notifier 324 provides guidance with a notification form according to the user such as in visual form by using the display unit 250 or in audio form by using the voice output unit 260 based on travel route information stored in the memory 290 and having been acquired in advance according to the driving status. The guidance is related to the travel of the vehicle, which may be for assisting the drive of the vehicle. For example, as the output through the visual form or the audio form, a predetermined arrow or a symbol may be displayed on the display unit 250, or guidance such as “Turn right in 700 meters at intersection OOO toward ΔΔΔ”, “You have deviated from the travel route” and “Traffic-jam ahead” is output in the audio form from the voice output unit 260. Specifically, the guidance notifier 324 acquires the notification form information 514B from the process state setting unit 310. The guidance notifier 324 notifies the above-described variety of guidance with the notification form according to the user based on the notification form information 514B, specifically the notification form including a small or large number of times of notification, an early or late timing of the notification, whether or not the map is displayed in accordance with the traveling direction, and the like. When acquiring predetermined notification form information about predetermined notification, the guidance notifier 324 notifies variety of guidance with the notification number of times, notification timing or map display that reflects the notification form of the predetermined notification information.

The map matching section 325 performs the map matching process for displaying the current position recognized by the current-position recognizer 321 based on the map information obtained from the map information storage section 270. As described earlier, the map matching section 325 typically uses the matching data for performing the map matching process to modify or correct the current position information to prevent the current position superimposed on the map on the display unit 250 from being located off the road in the map on the display unit 250.

The information retriever 326 hierarchically retrieves and acquires the retrieval information stored in the map information storage section 270 on the basis of the item information such as shops and facilities in response to, for example, a retrieval request for the retrieval information set at the input unit 240.

The music reproducing unit 330 reproduces music with a predetermined reproduction state. The music reproducing unit 330 includes a music selecting section (music selection processor) 331, a music reproduction processor (music output processor) 332 and the like. The response voice analyzer 311, the registration judging section 312, the state setting controller 313, the setting information generator 314, the navigation processor 320, the music selecting section 331 and the music reproduction processor 332 form the process control device of the present invention.

The music selecting section 331 selects music according to the user. Specifically, the music selecting section 331 acquires the selected music information 514C from the process state setting unit 310. The music selecting section 331 retrieves and acquires the music individual data corresponding to the music of this selected music information 514C from the music data storage section 280. The music selecting selection 331 outputs on a screen of the display unit 250 an indication notifying that the music is selected in accordance with the user, together with the name or the player of the music of the music related information contained in the music individual data. The name or the player of the music or the indication notifying that the music is selected may be output as a voice from the voice output unit 260. When an operation signal for selecting predetermined music based on an input operation at the input unit 240, the music selecting section 331 retrieves and acquires music individual data corresponding to the predetermined music from the music data storage section 280 and outputs the name or the player of the music of music related information of this music individual data on the screen of the display unit 250.

The music reproduction processor 332 outputs or reproduces the music selected by the music selecting section 331 from the sound generator 400 using an output form according to the user. Specifically, the music reproduction processor 332 acquires the music output form information 514D from the process state setting unit 310. When acquiring an operation signal for reproducing the music selected by the music selecting section 331, the music reproduction processor 332 acquires the music data of the music individual data acquired by the music selecting section 331. Then, the music reproduction processor 332 outputs the music from the sound generator 400 based on the music data using the output form corresponding to the user based on the music output form information 514D, specifically the output form being an output level of high-pitched sound and low-pitched sound, auditory lateralization, an output balance of the speaker 410, a setting of delay and an output form suitable for music of a particular genre. When acquiring output form information for outputting the music selected by the input operation at the input unit 240 using a predetermined output form, the music reproduction processor 332 outputs music from the sound generator 400 with the predetermined output form of this output form information.

The timer 340 recognizes the current date and time typically based on the reference pulse of an internal clock. The timer 340 appropriately outputs the recognized current date/time information of the recognized current date and time.

[Operation of Navigation System]

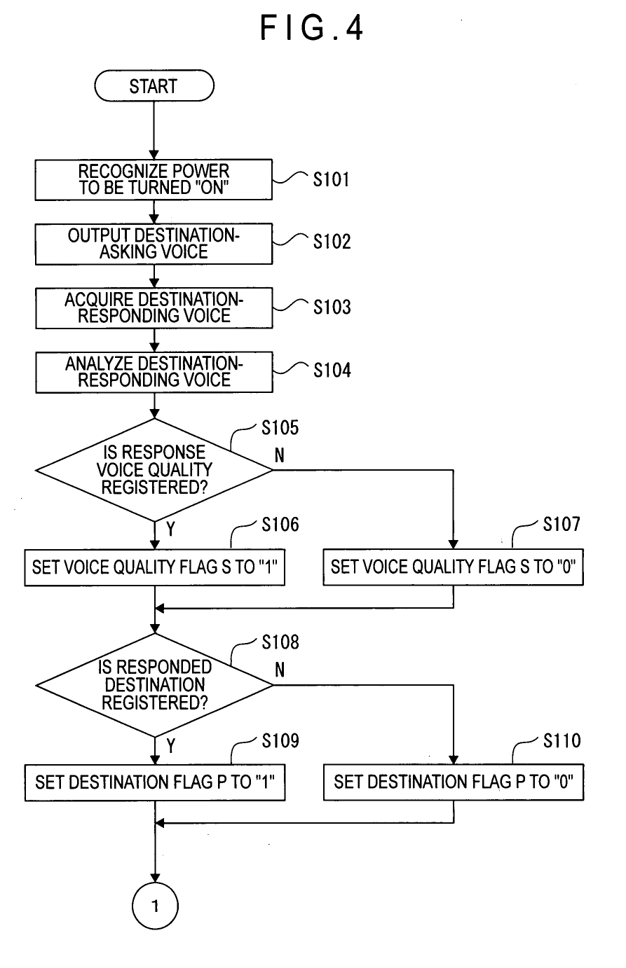

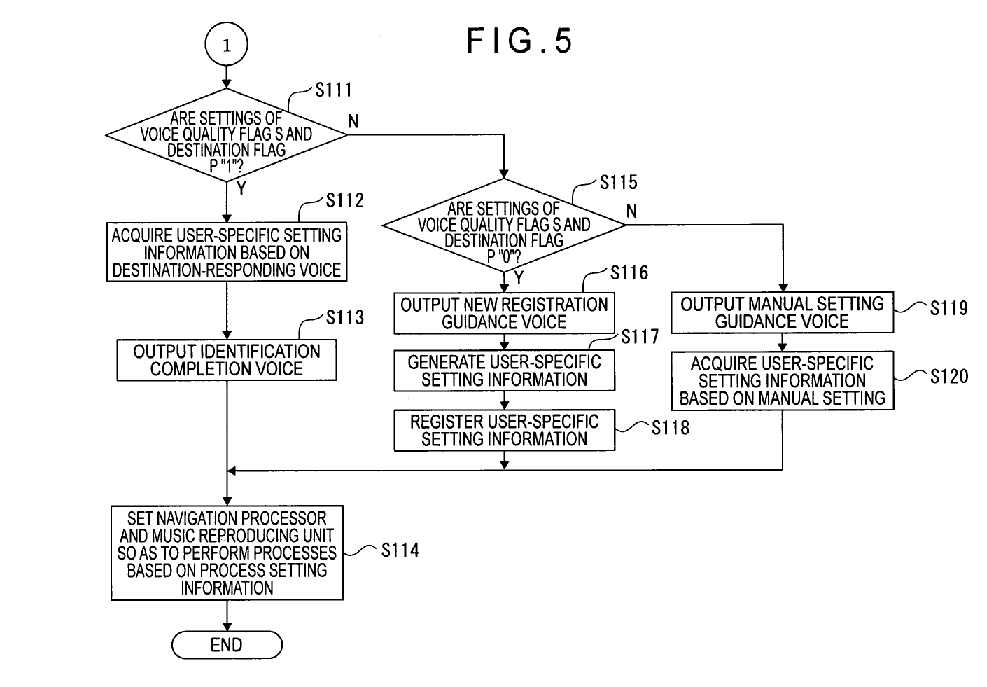

Now, a process state setting as an operation of the navigation system 100 will be described with reference to the attached drawings. FIGS. 4 and 5 are each a flowchart showing the process state setting.

First, a user turns on the navigation device 200 with a power switch (not shown). As shown in FIG. 4, when the response voice analyzer 311 of the process state setting unit 310 recognizes that the navigation device 200 is turned on (Step S101), the processor 300 of the navigation device 200 controls the voice output unit 260 to output the destination-asking voice such as “Where are you going?” (Step S102). When the destination-responding voice such as “To office.” is provided by the user, the microphone 230 collects this destination-responding voice to output the response voice information to the response voice analyzer 311. Upon acquisition of the destination-responding voice of the response voice information, (Step S103), the response voice analyzer 311 analyzes the destination-responding voice (Step S104) to generate the response voice quality recognition information about the response voice quality and the responded destination information in which a predetermined time is associated with the responded destination. Thereafter, the registration judging section 312 of the process state setting unit 310 acquires the response voice quality recognition information to judge whether or not the voice quality of the destination-responding voice is registered in the user-specific setting list information 500 (Step S105).

In Step S105, when judging that the response voice quality is registered, the registration judging section 312 sets the voice quality flag S stored in the memory 290 to “1” (Step S106). On the other hand, when judging that the response voice quality is not registered, the registration judging section 312 sets the voice quality flag S to “0” (Step S107). After setting the voice quality flag S through the processes of Steps S106 and S107, the registration judging section 312 acquires the responded destination recognition information to judge whether or not the responded destination associated with the predetermined time of the destination-responding voice is registered in the user-specific setting list information 500 (Step S108).

In Step S108, when judging that the responded destination is registered (Step S108), the registration judging section 312 sets the destination flag P stored in the memory 290 to “1” (Step S109). On the other hand, when recognizing that the responded destination is not registered, the registration judging section 312 sets the destination flag P to “0” (Step S110). Then, after the registration judging section 312 sets the destination flag P through the processes of Steps S109 and S110, the process state setting unit 310 operates the state setting controller 313 to judge whether or not both of the voice quality flag S and the destination flag P are set to “1” (Step S111).

When judging that both of the settings of the flags S, P are “1” in Step S111, the state setting controller 313 judges that the user can be identified based on the destination-responding voice. Then, the state setting controller 313 acquires the user-specific setting information 510 based on this destination-responding voice (Step S112) and controls the voice output unit 260 to output the identification completion voice such as “You are Taro. Settings are provided according to your preference.” (Step S113). The state setting controller 313 sets the navigation processor 320 and the music reproducing unit 330 so as to perform processes based on the process setting information 514 of the acquired user-specific setting information 510 (Step S114), and terminates the process state setting. Specifically, the state setting controller 313 sets the navigation processor 320 so as to set a travel route using the setting condition according to the user of the user-specific setting information 510 and to notify the guidance using the notification form according to the user. Likewise, the state setting controller 313 sets the music reproducing unit 330 so as to automatically select music according to the user of the user-specific setting information 510 and to output the music using the output form of a sound corresponding to the user.

On the other hand, in Step S111, when judging that both of the settings of the flags S, P are not “1”, the state setting controller 313 judges whether or not both of the settings of the flags S, P are “0” (Step S115). When judging that both of the settings of the flags S, P are “0” in Step S115, the state setting controller 313 recognizes that the user-specific setting information 510 of the user corresponding to the destination-responding voice is not registered. Then, the state setting controller 313 controls the voice output unit 260 to output the new registration guidance voice such as “You are newly registered.” (Step S116). Thereafter, the setting information generator 314 of the process state setting unit 310 generates, based on various items set by the input operation at the input unit 240 by the user who has made the destination-responding voice, the user-specific setting information 510 corresponding to the user (Step S117) to register the user-specific setting information 510 in the user-specific setting list information 500 (Step S118). Then, the state setting controller 313 sets the navigation processor 320 and the music reproducing unit 330 so as to perform processes based on the process setting information 514 of the user-specific setting information 510 registered by the setting information generator 314. In short, the state setting controller 313 performs the process of Step S114.

In Step S115, when judging that both of the settings of the flags S, P are not “0”, namely judging that the setting of one of the flags S, P is “0” and that of the other one is “1”, the state setting controller 313 judges that the user cannot be identified based on the destination-responding voice. Then, the state setting controller 313 controls the display unit 250 to display the list of the details of the registered user-specific setting information 510 and controls the voice output unit 260 to output the manual setting guidance voice such as “Please manually input a setting” (Step S119). Thereafter, the state setting controller 313 acquires, based on a setting input at the input unit 240 for selecting one piece of the displayed user-specific setting information 510, this selected user-specific setting information 510. Specifically, the state setting controller 313 acquires the user-specific setting information 510 based on the manual setting of the user (Step S120). The state setting controller 313 performs the process of Step S114.

### Advantages of First Embodiment

As described above, in the first embodiment, the processor 300 of the navigation device 200 operates the response voice analyzer 311 of the process state setting unit 310 to acquire the response voice information of the destination-responding voice collected by the microphone 230. The state setting controller 313 of the process state setting unit 310 recognizes that the vehicle is used by the user who has made the destination-responding voice based on the destination-responding voice of the response voice information acquired by the response voice analyzer 311 and identifies the user of the vehicle. Then, the state setting controller 313 performs a control such that the navigation processor 320 and the music reproducing unit 330 perform processes according to the identified user. Accordingly, the navigation device 200 can perform a travel route setting and a music selection in accordance with the user's preference without necessity for the user to input the process states of the navigation processor 320 and the music reproducing unit 330.

The state setting controller 313 controls the music reproducing unit 330 to output the music according to the user's preference. Accordingly, the user can comfortably drive the vehicle with the music according to one's preference provided by the navigation device 200.

The state setting controller 313 controls the music reproducing unit 330 to select the music in accordance with the user's preference. Accordingly, the user can comfortably drive the vehicle with the music according to one's preference output under the control of the navigation device 200.

In addition, the state setting controller 313 sets the music reproducing unit 330 so as to output the music with the output form according to the user's preference, the output form typically being an output level of high-pitched sound and low-pitched sound, auditory lateralization, a setting of delay and the like. Accordingly, the user can comfortably drive the vehicle with the music output with the output form according to one's preference under the control of the navigation device 200.

The navigation device 200 includes the memory 290 that stores the user-specific setting information 510 in which the registration voice quality information 511, the registration destination information 512 and the process setting information 514 are associated as a single data structure. The state setting controller 313 retrieves and acquires from the memory 290 the registration voice quality information 511 corresponding to the response voice quality recognized by the response voice analyzer 311 and the user-specific setting information 510 that contains the registration destination information 512 corresponding to the responded destination. Then, the state setting controller 313 performs a control such that the navigation processor 320 and the music reproducing unit 330 perform processes according to the user based on the process setting information 514 of the acquired user-specific setting information 510. Accordingly, the navigation device 200 can recognize the setting of the process according to the user's preference with a simple method of only retrieving the information 511, 512 corresponding to the destination-responding voice. Therefore, the navigation device 200 can easily perform the process according to the user's preference.

When recognizing the user-specific setting information 510 corresponding to the destination-responding voice is not stored in the memory 290, the state setting controller 313 operates the setting information generator 314 to generate the user-specific setting information 510 corresponding to the destination response voice and to store the generated user-specific setting information 510 in the memory 290. With the arrangement, since the navigation device 200 generates the user-specific setting information 510 corresponding to a new user who uses the vehicle for the first time, when the user uses the vehicle next time, the navigation device 200 can perform a process according to the user's preference without necessity for the user to input the process state.

The response voice analyzer 311 recognizes the responded destination as the destination of the vehicle based on the destination-responding voice. Then, the state setting controller 313 identifies the user based on the responded destination recognized by the response voice analyzer 311. Accordingly, the navigation device 200 can set a travel route, select music or set an output form of the music based on conditions respectively corresponding to different destinations for one user.

Further, the response voice analyzer 311 recognizes the response voice quality as the voice quality of the user based on the destination-responding voice. Then, the state setting controller 313 identifies the user based on the response voice quality recognized by the response voice analyzer 311. With the arrangement, the navigation device 200 can securely identify the user without the necessity for the user to input one's name or the like. Accordingly, the user-friendliness of the navigation device 200 can be enhanced.

The user can operate the navigation device 200 with the destination-responding voice so as to perform a process according to the user's preference from, for instance, a position remote from the navigation device 200. Accordingly, the user-friendliness of the navigation device 200 can further be enhanced. In addition, the navigation device 200 can recognize the response voice quality and the responded destination from the destination-responding voice, so that more information can be recognized as compared to an arrangement for acquiring a fingerprint or an iris which can hardly provide information other than physical characteristics of the user.

The response voice analyzer 311 controls the voice output unit 260 to output the destination-asking voice such as “Where are you going?” for prompting the user to make the destination-responding voice. With the arrangement, the user can operate the navigation device 200 to perform a process according to the user's preference only by making the destination-responding voice as a response to the destination-asking voice. Accordingly, the user-friendliness of the navigation device 200 can further be enhanced.

When acquiring the destination-responding voice, the response voice analyzer 311 recognizes the current time and day of the week based on the current time/date information from the timer 340, namely recognizes the time and the day of the week when the vehicle is used. Then, the state setting controller 313 identifies the user based on the time and the day of the week for using the vehicle recognized by the response voice analyzer 311. Accordingly, the navigation device 200 can perform a process according to conditions respectively corresponding to different times and days of the week for one user. In addition, since the navigation device 200 acquires the information about the time and the day of the week from the timer 340, the navigation device 200 can recognize the time and the day of the week when the vehicle is used without necessity for the user to make a voice for providing the time and the day of the week. Accordingly, the user-friendliness of the navigation device 200 can further be enhanced.

The state setting controller 313 controls the navigation processor 320 to set the travel route in accordance with the user's preference. Accordingly, the user can comfortably drive the vehicle based on the travel route that is set by the navigation device 200 in accordance with one's preference. Accordingly, the navigation device 200 can support the travel of the vehicle more properly.

The state setting controller 313 sets the navigation processor 320 so as to set the travel route from the current position to the destination with a condition according to the user's preference by, for instance, reflecting whether or not a narrow road is set as the travel route. With the arrangement, the user can drive the vehicle more comfortably based on the travel route set with the setting condition according to the one's preference. Accordingly, the navigation device 200 can support the travel of the vehicle more properly.

In addition, the state setting controller 313 sets the navigation processor 320 so as to notify the variety of guidance of the travel route with a notification form according to the user's preference, specifically the notification form including a small or large number of times of notification, an early or late timing of the notification and the like. With the arrangement, the user can drive the vehicle more comfortably based on various types of guidance notified with the timing or the number of times according to the one's preference. Accordingly, the navigation device 200 can support the travel of the vehicle more properly.

The process control device of the present invention is applied to the navigation device 200 that performs processes such as the travel route setting and the music reproduction. Accordingly, the navigation device 200 that can perform processes according to the user's preference and thus is highly user-friendly can be provided.

### Modification of First Embodiment

The present invention is not limited to the first embodiment above, but includes modifications and improvements as long as the object of the present invention can be attained.

Specifically, it may be so arranged that the state setting controller 313 sets one of the navigation processor 320 and the music reproducing unit 330 so as to perform a process according to the user. Although the embodiment is exemplified by an arrangement in which the state setting controller 313 sets the navigation processor 320 in the states of setting the travel route in accordance with the user's preference and notifying the various types of guidance of the travel route with a notification form according to the user's preference, the state setting controller 313 may set the navigation processor 320 in only one of the states. Although the embodiment is exemplified by an arrangement in which the state setting controller 313 sets the music reproducing unit 330 in the states of selecting music in accordance with the user's preference and outputting the music with an output form according to the user's preference, the state setting controller 313 may set the music reproducing unit 330 in only one of the states. With those arrangements, the state setting controller 313 may not include a function for setting the navigation processor 320 or the music reproducing unit 330 in all of the above-described process states, so that the state setting controller 313 can be simplified as compared to the above-described arrangement of the embodiment. Accordingly, the cost of the navigation device 200 can be reduced. Processing load in the process state setting of the process state setting unit 310 can be reduced. Further, the process setting information 514 may not contain the information 514A to 514D. Accordingly, information amount of the user-specific setting information 510 can be reduced, and therefore more user-specific setting information 510 can be stored in the memory 290.

Although an arrangement in which the state setting controller 313 identifies the user based on an analysis result of the destination-responding voice analyzed by the response voice analyzer 311 is exemplified, the arrangement is not limited thereto. For example, the state setting controller 313 may identify the user based on travel statuses of the vehicle such as an accelerating status and an operating status in making turns which are recognized by the sensor 210. Also, the state setting controller 313 may identify the user based on the current position or the destination of the vehicle which are recognized by the current position recognizer 321 or the destination recognizer 322. With those arrangements, the navigation device 200 can perform a process in accordance with the user's preference without necessity for the user to make the destination-responding voice.

The response voice analyzer 311 may recognizes either one or two of the responded destination, response voice quality and the time and day of the week when the vehicle is used based on the destination-responding voice. With the arrangement, the response voice analyzer 311 may not include a function for recognizing all of the above-described items, thereby simplifying the arrangement of the response voice analyzer 311. Accordingly, the cost of the navigation device 200 can be reduced. In addition, the processes of Steps S105 to S107 and Steps S108 to 110 performed by the registration judging section 312 can be appropriately omitted. Accordingly, processing load in the process state setting performed by the process state setting unit 310 can be reduced. Further, the user-specific setting information 510 needs not contain the registration voice quality information 511 and the registration destination information 512. The information amount of the registration destination information 512 may be reduced. Accordingly, information amount of the user-specific setting information 510 can be reduced, and therefore more user-specific setting information 510 can be stored in the memory 290.

Instead of the response voice analyzer 311, a biological characteristic recognizer may be provided so that a biological characteristic is recognized by acquiring biological characteristic information about biological characteristics such as a fingerprint, an iris, a face, a teeth mark and a vein of each finger. Here, the biological characteristic signal serves as the usage state information of the present invention, while the biological characteristic recognizer serves as the usage state information acquirer of the present invention. The state setting controller 313 may then identify the user based on the biological characteristic recognized by the biological characteristic recognizer. With the arrangement, too, the navigation device 200 can securely identify the user without the necessity for the user to input one's name or the like. Accordingly, the user-friendliness of the navigation device 200 can be enhanced.

Instead of the response voice analyzer 311, a usage state recognizer may be provided so that a usage state is recognized by acquiring usage state information about a usage state of the vehicle such as an adjusted position of a seat or a rearview mirror of the vehicle and weight of the user. Here, the usage state recognizer functions as the usage state information acquirer of the present invention. The state setting controller 313 may then identify the user based on the usage state of the vehicle recognized by the usage state recognizer. With the arrangement, too, the navigation device 200 can perform a process in accordance with the user's preference without necessity for the user to input the process state.

As an arrangement in which the destination-asking question is not output from the voice output unit 260, the response voice analyzer 311 may acquire the destination-responding voice appropriately made by the user. With the arrangement, the response voice analyzer 311 may not include a function for outputting the destination-asking voice, thereby simplifying the arrangement of the response voice analyzer 311. Accordingly, the cost of the navigation device 200 can be reduced. In addition, the process of Step 102 can be omitted, thus further reducing the processing load in the process state setting performed by the process state setting unit 310.

The response voice analyzer 311 may control the voice output unit 260 to output the destination-asking voice based on the current position of the vehicle recognized by the current position recognizer 321 so as to newly acquire a destination-responding voice. For example, it may be so arranged that, when the current position is a point such as a station or a house of a friend where the user is highly likely switched or the number of users is highly likely changed, namely a point where the user is highly likely changed, the response voice analyzer 311 newly acquires a destination-responding voice. On the other hand, when the current position is a point such as a sightseeing spot where the user is less likely changed, the response voice analyzer 311 does not newly acquire a destination-responding voice. With the arrangement, in a case where the current position is, for instance, a station where the user is changed with relatively high possibility, the navigation device 200 may output the destination-asking voice without necessity for the user to temporarily turning off the navigation device 200. On the other hand, in a case where the current position is a sightseeing spot where the user is changed with a relatively low possibility, even when the navigation device 200 is turned off and then turned on again, the navigation device 200 does not output the destination-asking voice. Accordingly, as compared to an arrangement of the above-describe embodiment in which the destination-asking voice is output when it is recognized that the navigation device 200 is turned on, the navigation device 200 can prompt the user to make the destination-responding voice more appropriately.

It may be so arranged that, upon recognition that the user-specific setting information 510 corresponding to the destination-responding voice is not stored in the memory 290, the state setting controller 313 sets the navigation processor 320 and the music reproducing unit 330 so as not to perform processes, namely a security system may be provided to the navigation processor 320 and the music reproducing unit 330. With the arrangement, the navigation device 200 can be used only by a particular user whose user-specific setting information 510 has been registered.

In such a navigation device 200 provided having such security system, the security system of the navigation processor 320 or the music reproducing unit 330 may be unlocked when a certain input operation such as an input operation of security code is recognized. With the arrangement, the navigation device 200 may appropriately perform processes in accordance with a registered user who is sick and cannot make a voice registered in the registration voice quality information 511 or a new user who is allowed to use the navigation device 200.

The present invention is applicable to any arrangement for performing the travel support of the mobile body such as a navigation device that performs only a process about a travel route, a music reproducing device that reproduces only music, a radio device that outputs a radio voice, a television device that outputs a television image and a content reproducing device that reproduces content recorded in a recording medium such as a DVD. Without limiting to the arrangement in which the process control device is applied to the navigation device 200, the process control device is applicable to a process condition setting device, which is the process condition setting unit 310 arranged as a standalone device. Further, without limiting to the arrangement in which the travel support device is applied to the navigation device 200, the travel support device is applicable to a travel support processor, which is at least one of the process status setting section 310, the navigation processor 320 and the music reproducing unit 330 arranged as a standalone device. Further, without limiting to the arrangement in which the travel support device is applied to the navigation device 200, the travel support device is applicable to a travel support processor, which is at least on of the navigation processor 320 and the music reproducing unit 330 arranged as a standalone device.

While the functions described above are realized in the form of programs in the above description, the functions may be realized in any form including hardware such as a circuit board or elements such as IC (Integrated Circuit). In view of easy handling and promotion of the use, the functions are preferably stored and read from programs or recording media.

The specific structures and the operating procedures for the present invention may be appropriately modified as long as the object of the present invention can be achieved.

### Second Embodiment

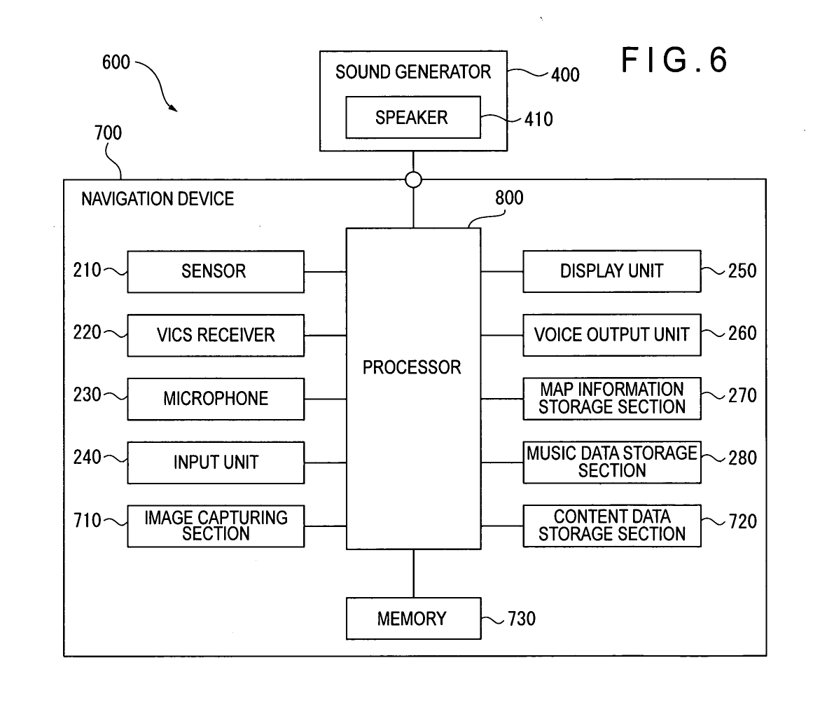

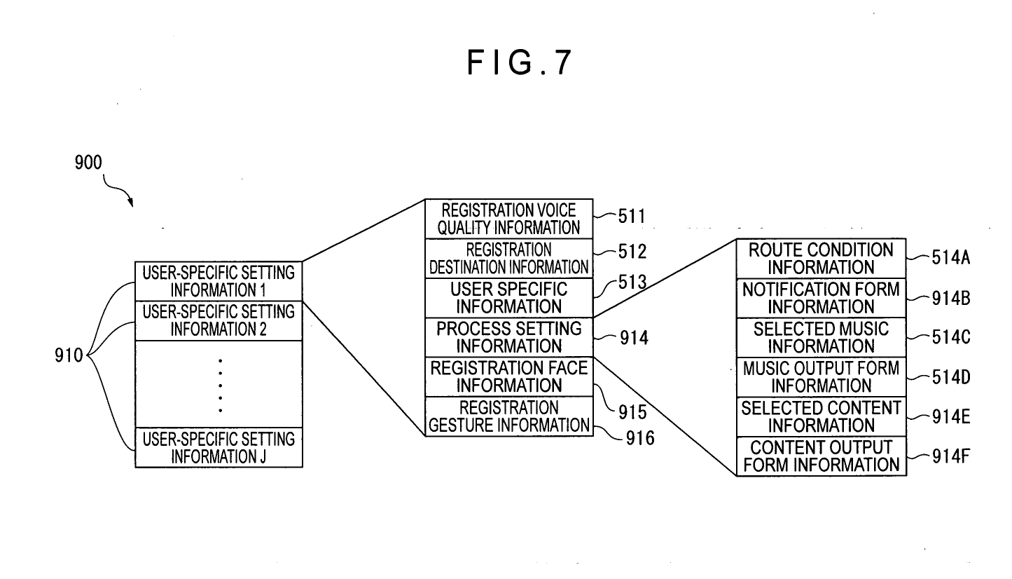

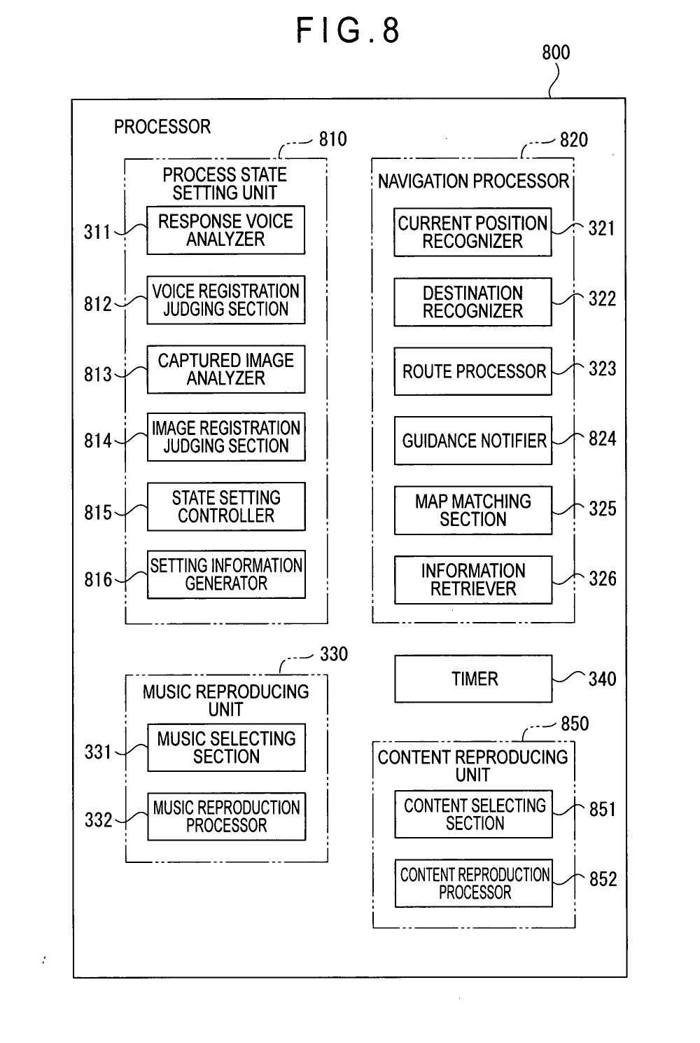

Next, a second embodiment of the present invention will be described with reference to the attached drawings. The second embodiment will be described by taking as an example a navigation system that includes a navigation device as a process control device of the present invention, the navigation system having an arrangement for supporting a travel of a mobile body (e.g., vehicle) as navigation, an arrangement for selecting and reproducing music and an arrangement for reproducing video content (hereinafter abbreviated as content) such as a movie or TV program. It should be noted that, similarly to navigation system 100 of the first embodiment, the navigation system is so designed to support a travel of any type of mobile body. FIG. 6 is a block diagram briefly showing an arrangement of a navigation system. FIG. 7 is a schematic diagram briefly showing an arrangement of a user-specific setting list information. FIG. 8 is a block diagram briefly showing an arrangement of a processor of the navigation device. Note that the arrangements same as those of the navigation system 100 in the first embodiment are indicated by the same name for omitting the description thereof. Also, the arrangements same as those of the navigation system 100 are indicated by the same reference numerals to simplify the description thereof.

[Arrangement of Navigation System]

Referring to FIG. 6, the reference numeral 600 denotes the navigation system. The navigation system 600 notifies guidance on a travel along with a travel progress of a mobile body (e.g. a vehicle) and reproduces music and content. The navigation system 600 appropriately sets a process status of each process in accordance with a user of the vehicle, namely a driver or a fellow passenger. Specifically, the navigation system 600 sets a narrow road as a travel route or increases the number of notification of the travel route in accordance with the user. In addition, the navigation system 600 selects music to be reproduced or sets an output form of sound in accordance with the user. Further, the navigation system 600 selects content to be reproduced or sets an output form of video or sound in accordance with the user. Note that the setting or the notification of a travel route according to the user or selection or output of music according to the user and selection or output of content according to the user correspond to a travel support. Further, a navigation function and a voice output function such as “Where are you going?” in the navigation system 600 and a wheel, a brake, an indicator and the like of the vehicle correspond to a travel support function. The mobile body is not limited to vehicles, but includes any type of mobile body such as aircrafts and ships. The navigation system 600 includes a navigation device 700, a sound generator 400 and the like.

The navigation device 700 may be, for example, an in-vehicle unit installed in a vehicle as a mobile body, a portable unit, a PDA, a mobile phone, a PHS or a portable personal computer. The navigation device 700 performs processes similar to those of the navigation device 200 of the first embodiment. Specifically, the navigation device 700 searches for a route to a destination, retrieves shops nearby, notifies various information about searched route and retrieved shops and information about a current position and a destination and reproduces music based on music data as content data being sound information and information. In addition, the navigation device 700 reproduces content based on music information, image information and content data as information stored in the navigation device 700 and content data recorded in a CD or a DVD. The navigation device 700 includes the sensor 210, the VICS receiver 220, the microphone 230, the input unit 240, an image capturing section 710, the display unit 250, the voice output unit 260, the map information storage section 270, the music data storage section 280, a content data storage section 720, a memory 730 as a state-specific process information storage section, a processor 800 as a computing section and the like.

The image capturing section 710 may be a so-called CCD (Charge Coupled Devices) camera, a CMOS camera or the like. The image capturing section 710 is arranged on, for instance, the front surface of the casing. The image capturing section 710 may be arranged on a front part of a ceiling or in a dashboard of an inner space of the vehicle. The image capturing section 710 acquires or captures an image of a face of a user (hereinafter, referred to as a face image) and an image set of a gesture of the user (hereinafter, referred to as a gesture image set) under the control of the processor 800. The face image is a still image with which a face can be identified. The gesture image set is a plurality of consecutive still images or a plurality of still images that are captured intermittently at a predetermined interval, with which a motion can be identified. Note that a face image set formed by a plurality of images similarly to the gesture image set may be used instead of the face image. The image capturing section 710 outputs to the processor 800 captured image information as characteristic information about the captured face image and gesture image set.

The content data storage section 720 readably stores content list data. The content data storage section 720 may include, similarly to the music data storage section 280, drives or drivers for readably storing data on a recording medium such as a magnetic disk like an HD (Hard Disk), optical discs like a CD and a DVD and a memory card.

The content list data is data about a list of content to be reproduced. The content list data is arranged such that at least one piece of content individual data is associated as a single data structure.

The content individual data is information about a single piece of content. The content individual data is structured in a table in which content data, content related information and the like are associated as a single data structure. The content individual data sometimes contains only content data. The content data is data used in reproducing content. The content data contains content in a reproducible manner, the content being MPEG format, AVI (Audio Visual Interleaved) format or the like. The content related information is information about content to be reproduced by the content data. Specifically, the content related information is structured in a table in which content name information containing information about a name of content as data, performer information containing information about a performer as data, a reproduction time information containing information about a reproduction time of the content as data and the like are associated as a singe data structure.

The memory 730 readably stores the settings input at the input unit 240, various information such as user-specific setting list information 900 shown in FIG. 7 which is acquired or generated by the processor 800, the voice quality flag S, the destination flag P, a face flag A, a gesture flag B, a face-error flag E and a gesture-error flag F used in process status setting for setting process statuses according to a user and the like. The memory 730 also readably stores the voice data and the image data. In addition, the memory 730 stores various programs that run on the OS controlling the whole operation of the navigation device 700. The memory 730 may be those having the same arrangement as the memory 290.

The user-specific setting list information 900 is information about a list of settings of process statuses according to one user or each of a plurality of users. The user-specific setting list information 900 is structured such that at least one piece of user-specific setting information 910 as state-specific process information is associated as a single data structure.

The user-specific state setting information 910 is information about a setting of a process state according to a user. The user-specific setting information 910 is properly generated or deleted by the processor 800. The user-specific setting information 910 is structured such that the registered voice quality information 511, the registered destination information 512, the user specific information 513, process setting information 914, registration face information 915, registration gesture information 916 and the like are associated as a single data structure. The user-specific setting information 910 may not contain the information 511, 512 or may not contain the information 915, 916.

The process setting information 914 is information about the process state that is set in accordance with the user contained in the user specific information 513. The process setting information 914 is structured such that the route condition information 514A, notification form information 914B, the selected music information 514C, the music output form information 514D, selected content information 914E, content output form information 914F and the like are associated as a single data structure.

The notification form information 914B is information about a notification form of the travel route that is set in accordance with the user. Examples of the notification form set by the notification form information may 914B include whether or not the map is displayed in accordance with the traveling direction, the timing or the number of times of notification, an output level of high-pitched sound and low-pitched sound, auditory lateralization, an output balance of the speakers 410, whether or not a plurality of maps having different scales are displayed, whether or not two-screen display for displaying the map and content is employed, and brightness, hue, aspect ratio, luminance, RGB (Red Green Blue) and contrast of the display of the map, and the like. The selected content information 914E is information for identifying content to be selected in accordance with the user, e.g., information about a name, a performer or detail of the content. The content output form information 914F is information about an output form of sound or video in reproduction of content, which is set in accordance with the user. Examples of the output form of the sound set by the content output form information 914F may include an output level of high-pitched sound and low-pitched sound, auditory lateralization, an output balance of the speaker 410, a setting of delay and an output setting of sub-voice such as voice in English. Examples of the output form of the video set by the content output form information 914F may include brightness, hue, aspect ratio, luminance, RGB or contrast of display of the video and whether or not subtitles are displayed or not.

It should be noted that the process setting information 914 containing the above-described information 514A, 914B, 514C, 514D, 914E, 914F is exemplified, but the process setting information 914 may contain at least one of the information 514A 914B, 514C, 514D, 914E, 914F. Further, various conditions or forms set by the information 514A, 914B, 514C, 514D, 914E, 914F are not limited to those described above but may include other suitable conditions and forms.

The registration face information 915 is information about a face image of at least one user that is normally captured by the image capturing section 710, in which the whole face is captured substantially in-focus (hereinafter, referred to as a normal face image). Specifically, the registration face information 915 is image data that shows the whole face. Herein, the registration face information 915 may employ image data of a particular part of the face such as an eye, a nose, a mouth and an ear or information that is obtained by numerically converting relative positions of a plurality of particular parts of the face. The registration gesture information 916 is information about a gesture image set of at least one user that is normally captured by the image capturing section 710, in which the gesture is captured substantially in-focus (hereinafter, referred to as a normal gesture image set). Specifically, the registration gesture information 916 is serial image data that shows motions of gestures such as raising one's arm. The registration gesture information 916 may employ information in which characters or numerical values that express a characteristic of the motion are formed in data.

The face-error flag E indicates whether or not the normal face image is captured by the image capturing section 710. The face-error flag E being “0” indicates that the normal face image is captured. On the other hand, the face error-flag E being “1” indicates that the normal face image has not been captured, specifically indicating, for example, that the captured face image is completely out of focus, that the captured face image does not contain the whole face, or that the face image has not been captured due to a trouble of the image capturing section 710 or due to an undesired matter existing between the image capturing section 710 and the user. The gesture-error flag F indicates whether or not the normal gesture image set has been captured by the image capturing section 710. The gesture-error flag F being “0” indicates that the normal gesture image set has been captured. On the other hand, the gesture-error flag F being “1” indicates that the normal gesture image set has not been captured, specifically indicating that, for example, the captured gesture image set is completely out of focus, or that the normal gesture image set has not been captured due to a trouble of the image capturing section 710 or the like.

The face flag A indicates whether or not the registration face information 915 corresponding to the normal face image captured by the image capturing section 710 is contained in the user-specific setting list information 900, namely whether or not the corresponding registration face information 915 is registered. The face flag A being “0” indicates that the registration face information 915 corresponding to the normal face image is not registered, while the face flag A being “1” indicates the corresponding registration face information 915 is registered. The gesture flag B indicates whether or not the registration gesture information 916 corresponding to the normal gesture image set captured by the image capturing section 710 is registered in the user-specific setting list information 900. The gesture flag B being “0” indicates that the registration gesture information 916 corresponding to the normal gesture is not registered, while the gesture flag B being “1” indicates that the corresponding registration gesture information 916 is registered.

The processor 800 has various input/output ports (not shown) including a GPS receiving port connected to a GPS receiver, sensor ports respectively connected to various sensors, a VICS receiving port connected to a VICS antenna, a microphone port connected to the microphone 230, a key input port connected to the input unit 240, an image capturing port connected to the image capturing section 710, a display port connected to the display unit 250, a voice port connected to the voice output unit 260, a map storage port connected to the map information storage section 270, a music data storage port connected to the music data storage section 280, a content storage port connected to the content data storage section 720, a memory port connected to the memory 730 and a sound-generating port connected to the sound generator 400. As shown in FIG. 8, the processor 800 has various programs such as a process status setting unit (a computing section) 810, a navigation processor (a travel support process performing section) 820, the music reproducing unit 330, the timer 340, a content reproducing unit 850 and the like.

The process state setting unit 810 sets the process states of the navigation processor 820, the music reproducing unit 330 and the content reproducing unit 850 to states according to the user. The process state setting unit 810 includes the response voice analyzer 311, a voice registration judging section 812, a captured image analyzer 813, an image registration judging section 814, a state setting controller 815, a setting information generator 816 and the like. Here, the response voice analyzer 311 also functions as the usage state information acquirer of the present invention. The voice registration judging section 812 and the image registration judging section 814 also function as an information selection process controller, an information output process controller, a content selection process controller, a content output process controller, a music selection process controller, a music output process controller, an image selection process controller, an image output process controller and a travel support process controller of the present invention. The captured image analyzer 813 functions as characteristic information acquirer of the present invention. The state setting controller 815 functions as a user identification section of the present invention and further functions as the information selection process controller, the information output process controller, the content selection process controller, the content output process controller, the music selection process controller, the music output process controller, the image selection process controller, the image output process controller and the travel support process controller. The setting information generator 816 functions as a status-specific information generator of the present invention.

The response voice analyzer 311 outputs the destination-asking voice such as “Where are you going?” to acquirer the characteristic information of the destination-responding voice to this destination-asking voice and the response voice information as the usage state information. Also, the response voice analyzer 311 acquires the current time/date information about a current time and date from the timer 340. Then, the response voice analyzer 311 analyzes the destination-responding voice of the response voice information and stores the response voice quality recognition information and the responded destination recognition information in the memory 730. Also, the response voice analyzer 311 outputs the user-asking voice such as “Who are you?” to acquire the user-responding voice to this user-asking voice. Then, the response voice analyzer 311 analyzes the user-responding voice and generates the responded user name recognition information, which is stored in the memory 730.

The voice registration judging section 812 performs processes similar to those of the registration judging section 312 of the first embodiment. The voice registration judging section 812 judges whether or not the registration voice quality information 511 and the registration destination information 512 corresponding to the destination-responding voice is registered in the user-specific setting list information 900 and appropriately sets the flags S, P of the memory 730.

The captured image analyzer 813 analyzes the face image captured by the image capturing section 710 to judge whether or not the face image is normal. Specifically, upon recognition of the output of the destination-asking voice, the captured image analyzer 813 operates the image capturing section 710 to capture the face image and output the captured image information. When acquiring the face image of the captured image information, the captured image analyzer 813 recognizes whether or not the whole face has been captured based on a color or a geometric shape of the face image. When recognizing that the whole face has not been captured, e.g., when a predetermined part of the face cannot be recognized because the captured image is completely out of focus, or when no image has been captured due to a trouble or the like of the image capturing section 710, the captured image analyzer 813 judges that the normal face image has not been captured by the image capturing section 710 and sets the face-error flag E of the memory 730 to “1”. On the other hand, when recognizing that the whole face has been captured substantially in focus, the captured image analyzer 813 judges that the normal face image has been captured and sets the face-error flag E to “0”. Here, when the face image is that of the face wearing sunglasses or a facemask, it is recognized that the normal face image has been captured. The captured image analyzer 813 acquires the face image captured by the image capturing section 710 as the normal face image. The captured image analyzer 813 then generates normal face image information of the acquired normal face image, which is stored in the memory 730.

The captured image analyzer 813 analyzes the gesture image set captured by the image capturing section 710 to judge whether or not the gesture image set is normal. Specifically, the captured image analyzer 813 outputs a gesture requesting voice such as “Please make a gesture” from the voice output unit 260. Then, when recognizing that a predetermined time period (e.g., 2 seconds) elapses from the output of the gesture requesting voice, the captured image analyzer 813 operates the image capturing section 710 to capture the gesture image set and output the captured image information. When acquiring the gesture image set of the captured image information, the captured image analyzer 813 judges whether or not a motion of a predetermined part has been captured based on a color or a geometric shape of the gesture image set. When recognizing that the motion of the predetermined part has not been captured, e.g., when the predetermined part cannot be recognized because the captured image is completely out of focus, or when no image has been captured due to a trouble or the like of the capturing section 710, the captured image analyzer 813 judges that the normal gesture image set has not been captured by the image capturing section 710 and sets the gesture-error flag F of the memory 730 to “1”. On the other hand, when recognizing that the motion of the predetermined part has been captured substantially in focus, the captured image analyzer 813 judges that the normal gesture image set has been captured and sets the gesture-error flag F to “0”. Then, the captured image analyzer 813 acquires the gesture image set captured by the image capturing section 710 as the normal gesture image set. The captured image analyzer 813 then generates normal gesture image set information of the acquired normal gesture image set, which is stored in the memory 730.

The image registration judging section 814 judges whether or not the registration face information 915 corresponding to the normal face image or the registration gesture information 916 corresponding to the normal gesture image set is registered in the user-specific setting list information 900. Specifically, the image registration judging section 814 acquires the normal face image information from the memory 730 and retrieves registration face information 915 corresponding to the normal face image of the normal face image information from the user-specific setting list information 900. When the corresponding registration face information 915 can be retrieved, namely when registration of the corresponding registration face information 915 is recognized, the image registration judging section 814 sets the face flag A of the memory 730 to “1”. On the other hand, when recognizing that the corresponding registration face information 915 is not registered, the image registration judging section 814 sets the face flag A to “0”. For example, when the normal face image is that of the face wearing glasses or a facemask and the face image of the registration face information 915 is that of the face not wearing the glasses or the facemask, the image registration judging section 814 recognizes the normal face image is not registered. It may be so arranged that even when the normal face image is that of the face wearing the glasses or the like, the normal face image is recognized to be registered if a predetermined part of the face (e.g., ear, profile) matches with the face image of the registration face information 915. Likewise, the image registration judging section 814 acquires the normal gesture image set information from the memory 730 and retrieves the registration gesture information 916 corresponding to the normal gesture image set of the normal gesture image set information from the user-specific setting list information 900. When recognizing that the corresponding registration gesture information 916 is registered, the image registration judging section 814 sets the gesture flag B of the memory 730 to “1”, while when recognizing that the corresponding registration gesture information 916 is not registered, the image registration judging section 814 sets the gesture flag B to “0”.

The state setting controller 815 performs processes similar to those of the state setting controller 313 in the first embodiment based on the judgments of the voice registration judging section 812, the captured image analyzer 813 and the image registration judging section 814, namely sets the navigation processor 820, the music reproducing unit 330 and the content reproducing unit 850 so as to perform processes in accordance with the user of the vehicle. Specifically, the state setting controller 815 acquires the face-error flag E and the gesture-error flag F of the memory 730. Then, when recognizing that both of the settings of the face-error flag E and the gesture-error flag F are “0”, the state setting controller 815 recognizes that the normal face image and the normal gesture image set can be acquired and acquires the face flag A and the gesture flag B of the memory 730. When recognizing that both of the settings of the face flag A and the gesture flag B are “1”, the state setting controller 815 judges that the user can be identified based on the normal face image and the normal gesture image set and acquires the user-specific setting information 910 from the memory 730. For example, the state setting controller 815 retrieves and acquires the user-specific setting information 910 that contains the registration face information 915 and the registration gesture information 916 retrieved by the image registration judging section 814. Then, the state setting controller 815 outputs an identification completion voice based on the user specific information 513 of this user-specific setting information 910. The state setting controller 815 then outputs the route condition information 514A and the notification form information 914B contained in the process setting information 914 of this user-specific setting information 910 to the navigation processor 820, the selected music information 514C and the music output form information 514D to the music reproducing unit 330, and the selected content information 914E and the content output form information 914F to the content reproducing unit 850. Specifically, the state setting controller 815 performs a control such that the navigation processor 820, the music reproducing unit 330 and the content reproducing unit 850 perform processes according to the user based on the process setting information 914.

When recognizing that both of the settings of the face flag A and the gesture flag B are “0”, the state setting controller 815 judges that the user-specific setting information 910 of the user corresponding to the normal face image and the normal gesture image set is not registered in the user-specific setting list information 900 and outputs a new registration guidance voice. The state setting controller 815 then controls the setting information generator 816 to generate the user-specific setting information 910 corresponding to the user of the normal face information and the normal gesture image set and to register the generated user-specific setting information 910 in the user-specific setting list information 900. Subsequently, the state setting controller 815 performs a control such that the navigation processor 820, the music reproducing unit 330 and the content reproducing unit 850 perform processes according to the user based on the user-specific setting information 910 registered by the setting information generator 816.

When recognizing that the setting of one of the face flag A and the gesture flag B is “0” while the setting of the other is “1”, the state setting controller 815 judges that the user cannot be identified based on the normal face image and the normal gesture image set. When recognizing that the setting of at least one of the face-error flag E and the gesture-error flag F is “1”, the state setting controller 815 judges that the normal face image and the normal gesture image set are not acquired and therefore the user cannot be identified based on the face image or the gesture image set. When judging that the user cannot be identified based on the image or the image set captured by the image capturing section 710, the state setting controller 815 acquires the voice quality flag S and the destination flag P of the memory 730. When recognizing that both of the settings of the voice quality flag S and the destination flag P are “1”, the state setting controller 815 acquires the user-specific setting information 910 containing the registration voice quality information 511 and the registration destination information 512 retrieved by the voice registration judging section 812. Specifically, the state setting controller 815 performs a control such that the navigation processor 820, the music reproducing unit 330 and the content reproducing unit 850 perform processes according to the user based on the process setting information 914 of this acquired user-specific setting information 910.

When recognizing that both of the settings of the voice quality flag S and the destination flag P are “0”, the state setting controller 815 operates the setting information generator 816 to generate the user-specific setting information 910 of the user of the destination-responding voice and to register the generated user-specific setting information 910 in the user-specific setting list information 900. Thereafter, the state setting controller 815 performs a control such that the navigation processor 820, the music reproducing unit 330 and the content reproducing unit 850 perform processes according to the user based on the registered user-specific setting information 910.

When recognizing that the setting of one of the voice quality flag S and the destination flag P is “0” while the setting of the other is “1”, the state setting controller 815 judges that the user cannot be identified based on the destination-responding voice. The state setting controller 815 then displays a list of details of the user-specific setting information 910 of the memory 730 and outputs a manual setting guidance voice. When acquiring an operation signal for selecting one piece of the user-specific setting information 910 by the input operation at the input unit 240, the state setting controller 815 performs a control such that the navigation processor 820, the music reproducing unit 330 and the content reproducing unit 850 perform processes according to the user based on the selected user-specific setting information 910.

The setting information generator 816, similarly to the setting information generator 314 of the first embodiment, appropriately generates user-specific setting information 910 and registers the generated the user-specific setting information 910 in the user-specific setting list information 900. Specifically, the setting information generator 816 displays a list of details of the music related information of the music individual data stored in the music data storage section 280, and generates selected music information 514C that contains a name or a player of music of at least one piece of the music related information based on the input operation at the input unit 240. Likewise, the setting information generator 816 displays a list of details of the content related information of the content individual data stored in the content data storage section 720, and generates selected content information 914E that contains a performer, a name or details of content of at least one piece of the content related information based on the input operation at the input unit 240. The setting information generator 816 displays an indication requesting the user to set an output form of sound for the music, the travel route or the content, a setting condition of the travel route, and an output form of an image or a video of the map, the travel route or the content. When acquiring an operation signal for setting various output forms or various conditions through the input operation at the input unit 240, the setting information generator 816 generates the music output form information 514D, the route condition information 514A, the notification form information 914B and the content output form information 914F respectively containing the set various forms or conditions. Then, the setting information generator 816 generates the process setting information 914 containing the generated information 514A, 914B, 514C, 514D, 914E and 914F. The setting information generator 816 operates the response voice analyzer 311 to generate the responded user name recognition information and generates the user specific information 513 that contains the responded user name of the responded user name recognition information.

When recognizing request from the state setting controller 815 that requests generation of the user-specific setting information 910 corresponding to the user of the normal face image and the normal gesture image set, the setting information generator 816 acquires the normal face image information and the normal gesture image set information from the memory 730. Then, the setting information generator 816 generates the registration face information 915 that contains the normal face image of the normal face image information and the registration gesture information 916 that contains the normal gesture image set of the normal gesture image set information. The setting information generator 816 generates the user-specific setting information 910 that contains the generated information 513, 914 to 915, and registers the generated user-specific setting information 910 in the user-specific setting list information 900. Here, the user-specific setting information 910 generated based on the normal face image and the normal gesture image set does not contain the information 511, 512.

When recognizing request from the state setting controller 815 that requests generation of the user-specific setting information 910 corresponding to the user of the destination-responding voice, the setting information generator 816 acquires the response voice quality recognition information and the responded destination recognition information. Based on the acquired information, the setting information generator 816 generates the registration voice quality information 511 and the registration destination information 512. Further, the setting information generator 816 registers the user-specific setting information 910 that contains the generated information 511 to 513 and 914 in the user-specific setting list information 900. Here, the user-specific setting information 910 generated based on the destination-responding voice does not contain the information 915, 916.

The navigation processor 820, similarly to the navigation processor 320 in the first embodiment, appropriately generates various information about the travel of the vehicle. The navigation processor 820 includes the current position recognizer 321, the destination recognizer 322, the route processor 323, a guidance notifier (route notification processor) 824 as information output processor, the map matching section 325, the information retriever 326 and the like.

The guidance notifier 824 outputs guidance about the travel of the vehicle by displaying images on the display unit 250 and outputting a voice from the voice output unit 260 using notification forms according to the user. Specifically, the guidance notifier 824 acquires the notification form information 914B from the process state setting unit 810. The guidance notifier 824 notifies a variety of guidance using the notification forms according to the user, specifically the notification forms reflecting a small or large number of times of notification for the travel route information as information generated by the route processor 323, an early or late timing of the notification, whether or not the map as the image information and the information is displayed in accordance with the traveling direction, whether or not a plurality of maps having different scales is displayed, brightness, hue, aspect ratio, luminance, RGB and contrast of the display, and the like. When acquiring predetermined notification form information about predetermined notification, the guidance notifier 824 notifies variety of guidance with the notification timing, notification number of times or map display that reflects the notification form of the predetermined notification form information.

The music reproducing unit 330 reproduces music with a predetermined reproduction state. The music reproducing unit 330 includes the music selecting section (information selection processor, content selection processor and music selection processor) 331, the music reproduction processor (information output processor, content reproduction processor and music output processor) 332 and the like.

The content reproducing unit 850 reproduces content with a predetermined reproduction state. The content reproducing unit 850 includes a content selecting section (information selection processor, content selection processor and image selection processor) 851, a content reproduction processor (information output processor, content output processor and image display processor) 852 and the like.

The response voice analyzer 311, the voice registration judging section 812, the captured image analyzer 813, the image registration judging section 814, the state setting controller 815, the setting information generator 816, the music selecting section 331, the music reproduction processor 332, the guidance notifier 824, the content selecting section 851 and the content reproduction processor 852 form the process control device of the present invention.

The content selecting section 851 selects content according to the user. Specifically, the content selecting section 851 acquires the selected content information 914E from the process state setting unit 810. The content selecting section 851 retrieves and acquires the content individual data corresponding to the content of the selected content information 914E from the content data storage section 720. Then, the content selecting section 851 outputs on the screen an indication notifying that the content is selected in accordance with the user together with a name, a performer or details of the content of the content related information of this content individual data. Alternatively, the name, the performer or the details of the content or the indication notifying that the content is selected in accordance with the user may be output as a voice. When an operation signal for selecting predetermined content based on an input operation at the input unit 240, the content selecting section 851 retrieves and acquires content individual data corresponding to the predetermined content from the content data storage section 720, and outputs a name or the like of the content of content related information of this content individual data on the screen.

The content reproduction processor 852 outputs or reproduces the content selected by the content selecting section 851 from the display unit 250 or the sound generator 400 using an output form corresponding to the user. Specifically, the content reproduction processor 852 acquires the content output form information 914F from the process state setting unit 810. When acquiring an operation signal for reproducing the content selected by the content selecting section 851, the content selecting section 851 acquires content data of the content individual data acquired by the content selecting section 851. The content reproduction processor 852 displays video of the content on the display unit 250 based on the content data using the output form according to the user based on the content output form information 914F, the output form specifically including brightness, hue, aspect ratio and luminance, RGB or contrast of the display, a setting of subtitles and the like. Based on the content output form information 914F, a voice of the content is output from the sound generator 400 using the output form according to the user, the output form including a level of high-pitched sound and low-pitched sound, auditory lateralization, an output balance of the speakers 410, a setting of delay, an output setting of sub-voice such as English as another language and the like. When acquiring output form information indicating that the content selected by the input operation at the input unit 240 is output using a predetermined output form, the content reproduction processor 852 outputs content from the display unit 250 or the sound generator 400 using the predetermined output form of this output form information.

[Operation of Navigation System]

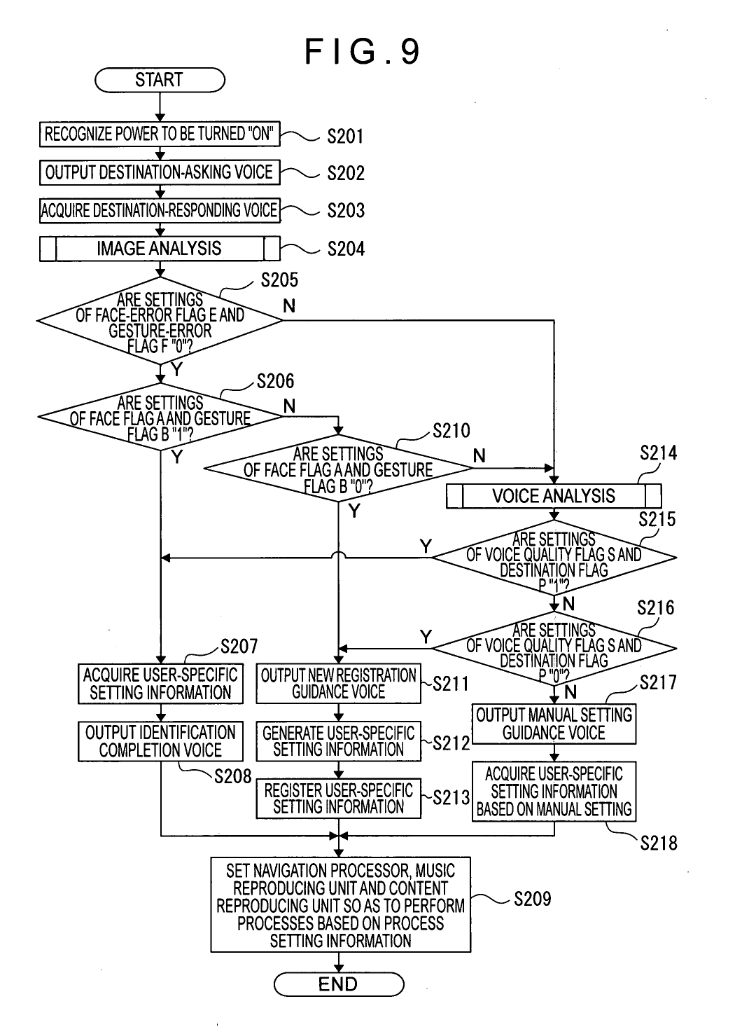

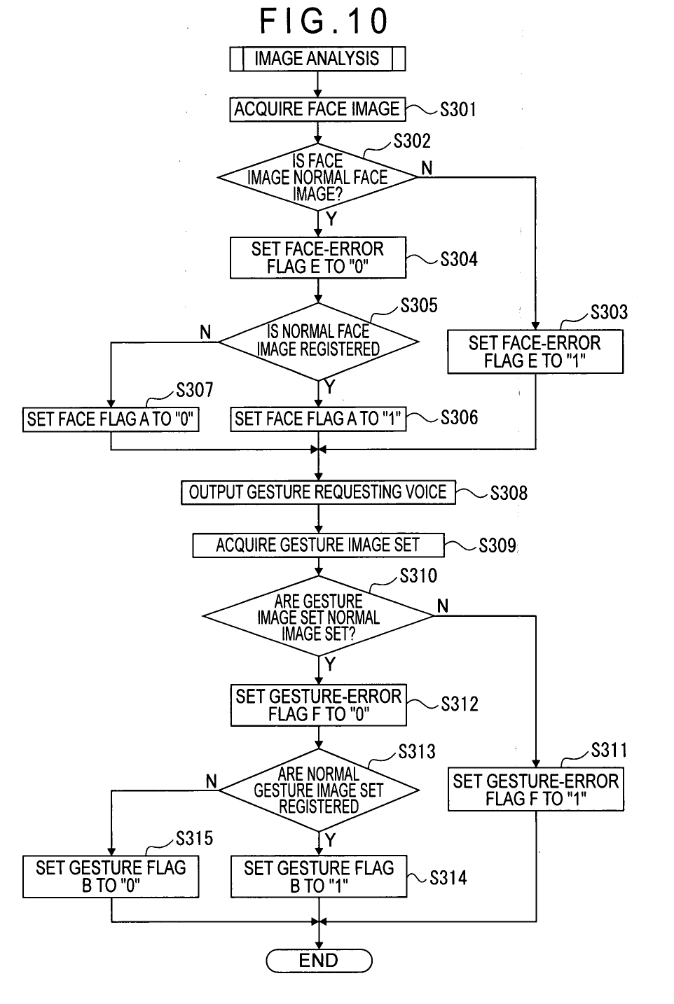

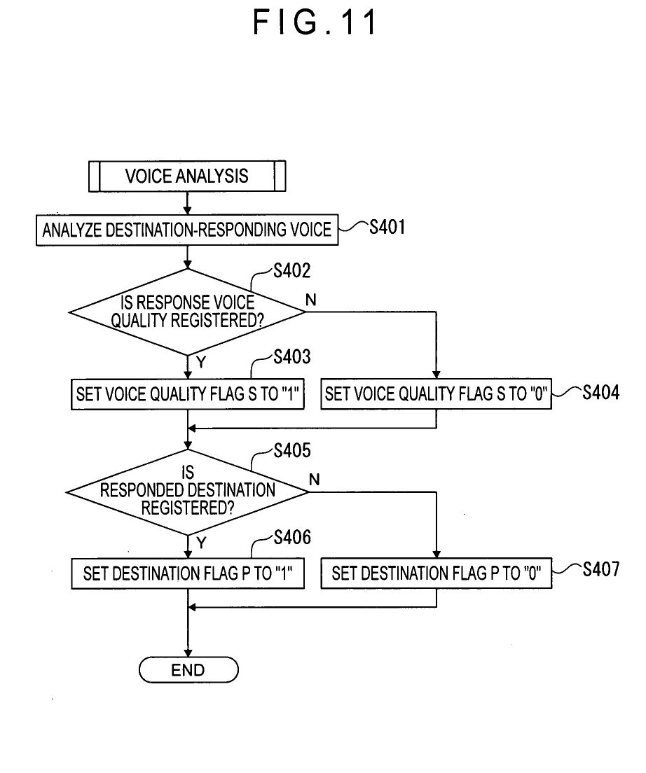

Now, process state setting as an operation of the navigation system 600 will be described with reference to the attached drawings. FIG. 9 is a flowchart showing the process state setting. FIG. 10 is a flowchart showing an image analysis. FIG. 11 is a flowchart showing a voice analysis.

First, a user turns on the navigation device 700 with a power switch (not shown). As shown in FIG. 9, the response voice analyzer 311 of the process state setting unit 810 recognizes that the navigation device 700 is turned on (Step S201), the processor 800 of the navigation device 700 controls the voice output unit 260 to output the destination-asking voice (Step S202). The process state setting unit 810 operates the response voice analyzer 311 to acquire the destination-asking voice of the response voice quality information from the microphone 230 to perform the image analysis (Step S204).

After the image analysis of Step S204, the state setting controller 815 of the process state setting unit 810 judges whether or not both of the settings of the face-error flag E and the gesture-error flag F are “0” (Step S205). When judging that both of the settings of the flags E, F are “0” in Step S205, the state setting controller 815 recognizes that the normal face image and the normal gesture image set can be acquired. Then, the state setting controller 815 judges whether or not both of the settings of the face flag A and the gesture flag B are “1” (Step S206). When judging that both of the settings of the flags A, B are “1” in Step S206, the state setting controller 815 judges that the user can be identified based on the normal face image and the normal gesture image set. Then, the state setting controller 815 acquires the user-specific setting information 910 based on the normal face image and the normal gesture image set (Step S207) and performs a control to output the identification completion voice (Step S208). Thereafter, the state setting controller 815 sets the navigation processor 820, the music reproducing unit 330 and the content reproducing unit 850 so as to perform processes based on the process setting information 914 of the acquired user-specific setting information 910 (Step S209), and terminates the process state setting.

In Step S206, when judging that both of the settings of the flags A, B are not “1”, the state setting controller 815 judges whether or not both of the settings of the flags A, B are “0” (Step S210). In Step S210, when judging that both of the settings of the flags A, B are “0”, the state setting controller 815 recognizes that the user-specific setting information 910 corresponding to the normal face image and the normal gesture image set is not registered and outputs the new registration guidance voice (Step S211). Then, the setting information generator 816 of the process state setting unit 810 generates, based on various items set by the input operation at the input unit 240 by the user corresponding to the normal face image and the normal gesture image set, the user-specific setting information 910 corresponding to the user (Step S212) to register the generated user-specific setting information 910 in the user-specific setting list information 900 (Step S213). In Step S210, when both of the settings of the flags A, B are judged to be “0”, the setting information generator 816 generates the user-specific setting information 910 corresponding to the normal face image and the normal gesture image set, namely the user-specific setting information 910 that does not contain the information 511, 512. Thereafter, the state setting controller 815 sets the navigation processor 820, the music reproducing unit 330 and the content reproducing unit 850 so as to perform processes based on the process setting information 914 of the user-specific setting information 910 registered by the setting information generator 816, namely performs the process of Step S208.

In Step S205, when judging that both of the settings of the error flags E, F are not “0”, namely at least one of the settings of the error flags E, F is “1”, the state setting controller 815 recognizes that the normal face image or the normal gesture image set cannot be acquired and performs the voice analysis (Step S214). In Step S210, when judging that both of the settings of the flags A, B are not “0”, namely at least one of the settings of the flags A, B is “1”, the state setting controller 815 recognizes that the user cannot be identified based on the normal face image or the normal gesture image set and performs the process of Step S214.

After the voice analysis of Step S214, the state setting controller 815 of the process state setting unit 810 judges whether or not both of the settings of the voice quality flag S and the destination flag P are “1” (Step S215). In Step S215, when both of the settings of the flags S, P are “1”, the state setting controller 815 acquires the user-specific setting information 910 based on the destination-responding voice acquired in Step S203, namely performs the process of Step S207. On the other hand, in Step S215, when judging that both of the settings of the flags S, P are not “1”, the state setting controller 815 judges whether or not both of the settings of the flags S, P are “0” (Step S216).

In Step S216, when judging that both of the settings of the flags S, P are “0”, the state setting controller 815 performs the process of Step S211. The setting information generator 816 generates, based on the various items set by the input operation at the input unit 240 by the user corresponding to the destination-responding voice, the user-specific setting information 910 corresponding to this user, namely performs the process of Step S212. In Step S210, when both of the settings of the flags A, B are judged to be “0”, the setting information generator 816 generates the user-specific setting information 910 of the user corresponding to the destination-responding voice, namely the user-specific setting information 910 that does not contain the information 915, 916.

In Step S216, when judging that both of the settings of the flags S, P are not “0”, namely at least one of the settings of the flags S, P is “1”, the state setting controller 815 performs a control such that the list of the details of registered user-specific setting information 910 is displayed and the manual setting guidance voice is output (Step S217). Thereafter, the user-specific setting information 910 acquires, based on a manual setting that is set at the input unit 240 for selecting one piece of the user-specific setting information 910, the selected user-specific setting information 910 (Step S218) and performs the process of Step S209.

Meanwhile, in the image analysis, as shown in FIG. 10, the captured image analyzer 813 of the process state setting unit 810 operates the image capturing section 710 to capture the face image of the user when, for instance, the user makes the destination-responding voice and output the captured image information. Then, when acquiring the face image of the captured image information (Step S301), the captured image analyzer 813 judges whether or not the face image is the normal face image (Step S302). When judging that the face image is not the normal face image in Step S302, the captured image analyzer 813 sets the face-error flag E of the memory 730 to “1” (Step S303). On the other hand, when judging that the face image is the normal face image in Step S302, the captured image analyzer 813 sets the face-error flag E to “0” (Step S304). Then, the image registration judging section 814 of the process state setting unit 810 judges whether or not the normal face image is registered in the user-specific setting list information 900 (Step S305). When judging that the normal face image is registered in Step S305, the face flag A of the memory 730 is set to “1” (Step S306). On the other hand, when judging that the normal face image is not registered in Step S305, the face flag A is set to “0” (Step S307).

After the settings of the flags E, A are completed in Steps S303, S306 and S307, the process state setting unit 810 operates the captured image analyzer 813 to output the gesture request voice such as “Please make a gesture” from the voice output unit 260 (Step S308). Then, when recognizing that a predetermined time period (e.g., 2 seconds) elapses from the output of the gesture requesting voice, the captured image analyzer 813 operates the image capturing section 710 to capture the gesture image set and output the captured image information. Thereafter, when acquiring the gesture image set of the captured image information (Step S309), the captured image analyzer 813 judges whether or not the gesture image set is the normal gesture image set (Step S310).

When judging that the gesture image set is not the normal gesture image set in Step S310, the captured image analyzer 813 sets the gesture-error flag F of the memory 730 to “1” (Step S311), and terminates the image analysis. On the other hand, when judging that the gesture image set is the normal gesture image set in Step S310, the captured image analyzer 813 sets the gesture-error flag F to “0” (Step S312). Then, the image registration judging section 814 judges whether or not the normal gesture image set is registered in the user-specific setting list information 900 (Step S313). When judging that the normal gesture image set is registered in Step S313, the image registration judging section 814 sets the gesture flag B of the memory 730 to “1” (Step S314), and terminates the image analysis. On the other hand, when judging that the normal gesture image set is not registered in Step S313, the image registration judging section 814 sets the gesture flag B to “0” (Step S315), and terminates the image analysis.

In the voice analysis, as shown in FIG. 11, the process state setting unit 810 operates the response voice analyzer 311 to analyze the destination-responding voice acquired in Step S203 (Step S401) to generate the response voice quality recognition information and the responded-destination information. Thereafter, the voice registration judging section 812 of the process state setting unit 810 judges whether or not the voice quality is registered in the user-specific setting list information 900 based on the response voice quality recognition information (Step S402).

In Step S402, when judging that the response voice quality is registered, the voice registration judging section 812 sets the voice quality flag S of the memory 730 to “1” (Step S403). On the other hand, when judging that the response voice quality is not registered in Step S402, the voice registration judging section 812 sets the voice quality flag S to “0” (Step S404). After setting the voice quality flag S through the processes of Steps S403 and S404, the voice registration judging section 812 judges whether or not the responded destination is registered in the user-specific setting list information 900 based on the responded destination recognition information (Step S405). In Step S405, when judging that the responded destination is registered, the voice registration judging section 812 sets the destination flag P of the memory 730 to “1” (Step S406) and terminates the voice analysis. On the other hand, when judging that the responded destination is not registered in Step S405, the voice registration judging section 812 sets the destination flag P to “0” (Step S407) and terminates the voice analysis.

### Advantages of Second Embodiment

As described above, the second embodiment provides the following advantages in addition to the advantages same as those of the first embodiment.

The processor 800 of the navigation device 700 operates the captured image analyzer 813 of the process state setting unit 810 to acquire the captured image information of the face image and the gesture image set captured by the image capturing section 710. The state setting controller 815 of the process state setting unit 810 identifies the user of the vehicle based on the face image and the gesture image set of the captured image information acquired by the captured image analyzer 813. Then, the state setting controller 815 performs a control such that the navigation processor 820, the music reproducing unit 330 and the content reproducing unit 850 perform processes according to the identified user. Accordingly, the navigation device 700 can perform the travel route search, the music selection and the content reproduction in accordance with the user's preference without necessity for the user to input the process states of the navigation processor 820, the music reproducing unit 330 and the content reproducing unit 850.

The state setting controller 815 of the process state setting unit 810 recognizes that the vehicle is used by the user who has made the destination-responding voice based on the destination-responding voice of the response voice information acquired by the response voice analyzer 311 and sets the components 820, 330, 850 so as to perform processes according to the user. With the arrangement, even when the user wears sunglasses or a facemask and it is recognized the registration face information 915 corresponding to the normal face image is not registered, the state setting controller 815 can identify the user with a voice. Accordingly, user-friendliness of the navigation device 700 can be enhanced.

The state setting controller 815 controls the content reproducing unit 850 to reproduce the content according to the user's preference. With the arrangement, the user can comfortably drive the vehicle with the reproduction of the content according to one's preference.

The state setting controller 815 sets the content reproducing unit 850 so as to select the content in accordance with the user's preference. With the arrangement, the user can watch the content according to one's preference before starting driving or during a rest time in a parking lot and the like and therefore the user can travel in the vehicle more comfortably.

The state setting controller 815 sets the content reproducing unit 850 so as to output the content in accordance with the user's preference. With the arrangement, the user can comfortably drive the vehicle with the content output in a state according to one's preference.

In addition, the state setting controller 815 sets the content reproducing unit 850 so as to output the content using the output form of a voice or sound according to the user's preference, the output form typically being an output level of high-pitched sound and low-pitched sound and a setting of sub-voice. With the arrangement, the user can comfortably drive the vehicle with the content output with the voice or sound according to one's preference.

Further, the state setting controller 815 sets the content reproducing unit 850 so as to display the content using the display form of an image or video according to the user's preference, the display form typically being brightness, hue of the display and a setting of subtitles. With the arrangement, the user can watch the content displayed with the image or video according to one's preference before starting driving or during a rest time in a parking lot and therefore the user can travel in the vehicle more comfortably.

The navigation device 700 includes the memory 730 that stores the user-specific setting information 910 in which the process setting information 914, the registration face information 915 and the registration gesture information 916 are associated as a single data structure. The state setting controller 815 retrieves and acquires from the memory 730 the user-specific setting information 910 that contains the registration face image information 915 corresponding to the normal face image and the registration gesture information 916 corresponding to the normal gesture image set, the normal face image and the normal gesture image set recognized by the captured image analyzer 813. Thereafter, the state setting controller 815 performs a control such that the components 820, 330, 850 perform processes according to the user based on the process setting information 914 of the acquired user-specific setting information 910. Accordingly, the navigation device 700 can recognize the setting of the process according to the user's preference with a simple method for only retrieving the information 915, 916 corresponding to the normal face image and the normal gesture image set, so that the navigation device 700 can perform the process according to the user's preference more easily.

When recognizing the user-specific setting information 910 corresponding to the normal face image and the normal gesture image set is not stored in the memory 730, the state setting controller 815 controls the setting information generator 816 to generate the user-specific setting information 910 corresponding to the normal face image and the normal gesture image set and to store the generated user-specific setting information 910 in the memory 730. With the arrangement, since the navigation device 700 generates the user-specific setting information 910 corresponding to a new user who uses the vehicle for the first time, when the user uses the vehicle next time, the navigation device 700 can perform a process according to the user's preference without necessity for the user to input the process state.

In addition, the state setting controller 815 sets the navigation processor 820 so as to output the travel route information using the output form according to the user's preference, the output form typically being an output level of high-pitched sound and low-pitched sound and an output balance of the speakers 410. With the arrangement, the user can recognize information about the travel route from the travel route information output with a voice according to one's preference without necessity of paying concentrated attention to the voice. Accordingly, the navigation device 700 can support the travel of the vehicle more properly.

The state setting controller 815 sets the navigation processor 820 so as to display the travel route information, the map and the like using the display form of an image or video according to the user's preference, the display form typically being whether or not a plurality of maps having different scales is displayed and brightness of the display. With the arrangement, the user can recognize information about the travel route from the travel route information displayed with the image or video according to one's preference, thereby, for instance, avoiding eyestrain. Accordingly, the navigation device 700 can support the travel of the vehicle more properly.

Further, the state setting controller 815 identifies the user based on the normal face image and the normal gesture image set recognized by the captured image analyzer 813. With the arrangement, the state setting controller 815 can securely identify the user without the necessity for the user to input one's name or the like. Accordingly, the user-friendliness of the navigation device 700 can be enhanced.

When recognizing that the destination-asking question is made, the captured image analyzer 813 operates the image capturing section 710 to capture the face image of the user. With the arrangement, as compared to an arrangement in which the face image is captured after outputting a voice for only notifying the capturing such as “Your face image is to be captured”, the capturing can be performed more quickly.

The captured image analyzer 813 controls the voice output unit 260 to output the gesture requesting voice such as “Please make a gesture” for prompting the user to make a gesture. With the arrangement, the captured image analyzer 813 can let the user recognize the timing for making the gesture, so that the gesture image set can be captured securely.

The process control device of the present invention is applied to the navigation device 700 that performs processes such as a travel route setting and a music or content reproduction. Accordingly, the navigation device 700 that can perform processes according to the user's preference and thus is highly user-friendly can be provided.

### Modification of Second Embodiment

The present invention is not limited to the second embodiment above, but includes, in addition to modifications similar to those of the first embodiment, modifications and improvements as long as the object of the present invention can be attained.

Specifically, it may be so arranged that the state setting controller 815 sets one or two of the components 820, 320, 850 so as to perform processes according to the user. Although there is exemplified the arrangement in which the state setting controller 815 sets the navigation processor 820 in the states of setting the travel route in accordance with the user's preference, notifying the variety of guidance about the travel route using the notification form according to the user's preference, outputting the variety of guidance with the voice according to the user's preference and outputting the variety of guidance with the video according to the user's preference, the state setting controller 815 may set the navigation processor 820 in one, two or three of the above states. Although the embodiment is exemplified by an arrangement in which the state setting controller 815 sets the music reproducing unit 330 in the states of selecting the music according to the user's preference and outputting the music using the output form according to the user's preference, the state setting controller 313 may set the music reproducing unit 330 in only one of the above states. Although there is exemplified the arrangement in which the state setting controller 815 sets the content reproducing unit 850 in the states of selecting the content according to the user's preference, outputting the sound using the output form according to the user's preference and displaying the image using the display form according to the user's preference, the state setting controller 815 may set the content reproducing unit 850 in one or two of the above states. With those arrangements, the state setting controller 815 may not include a function for setting the components 820, 330, 850 in all the above-described states, so that the state setting controller 815 can be simplified as compared to the above-described arrangement of the embodiment. Accordingly, the cost of the navigation device 700 can be reduced. Processing load in the process state setting performed by the process state setting unit 810 can be reduced. Further, the process setting information 914 needs not contain all of the information 514A, 914B, 514C, 514D, 914E, 914F. Accordingly, information amount of the user-specific setting information 910 can be reduced, and therefore more user-specific setting information 910 can be stored in the memory 730.

The captured image analyzer 813 may recognize only the normal face image. With the arrangement, the captured image analyzer 813 may not include a function for recognizing the normal gesture image set, thereby simplifying the arrangement of the captured image analyzer 813. Accordingly, the cost of the navigation device 700 can be reduced. In addition, the processes of Steps S308 to S315 performed by the components 813, 814 can be appropriately omitted. Accordingly, processing load in the image analysis performed by the components 813, 814 can be reduced. Further, the user-specific setting information 910 needs not contain the registration gesture information 916. Accordingly, information amount of the user-specific setting information 910 can be reduced, and therefore more user-specific setting information 910 can be stored in the memory 730.

The captured image analyzer 813 may recognize only the normal gesture image set. A method for identifying a person in such an arrangement, there may include: a method for identifying through similar gestures such as raising hands, in which a person is identified by a difference of raising angles of hands; and a method for identifying a person by storing a history of gestures and identifying a person based on the history. However, without limiting to these methods, any method can be employed as long as a person is identified based on the gesture. With the arrangement, the captured image analyzer 813 may not include a function for recognizing the normal face image, thereby simplifying the arrangement of the captured image analyzer 813. Accordingly, the cost of the navigation device 700 can be reduced. In addition, the processes of Steps S301 to S307 performed by the components 813, 814 can be appropriately omitted. Accordingly, processing load in the image analysis performed by the components 813, 814 can be reduced. Further, the user-specific setting information 910 needs not contain the registration gesture information 916. Accordingly, information amount of the user-specific setting information 910 can be reduced, and therefore more user-specific setting information 910 can be stored in the memory 730.

The following arrangement may be employed instead of storing the user-specific setting information 910 as the user-specific setting list information 900 in the memory 730. Specifically, similarly to the arrangement exemplified as a modification of the first embodiment, there may be employed an arrangement in which the normal face image and the normal gesture image set are acquired based on the current position of the vehicle. In this arrangement, when a user uses the navigation device 700 for the first time, user-specific setting information 910 is temporarily stored in the memory 730. Then, in a process state setting of the second time or thereafter in a state where the navigation device 700 is not turned off, the user-specific setting information 910 that is temporarily stored is used, and this user-specific setting information 910 is deleted when the navigation device 700 is turned off. With the arrangement, only user-specific setting information 910 of the user who actually uses the vehicle requires to be stored in the memory 730, so that the capacity of the memory 730 can be reduced.

The process state setting unit 810 may not include a function for identifying a user based on the destination-responding voice. With the arrangement, the response voice analyzer 311 can be simplified, while the voice registration judging section 812 can be omitted and therefore the process state setting unit 810 can be simplified. Accordingly, the cost of the navigation device 700 can be reduced. In addition, the processes of Step 214 to S216 can be appropriately omitted, thus further reducing the processing load in the process state setting performed by the process state setting unit 810. Further, the user-specific setting information 910 needs not contain the information 511, 512 and therefore the information amount of the user-specific setting information 910 can be reduced, so that more pieces of user-specific setting information 910 can be stored in the memory 730.

The captured image analyzer 813 may not include a function for judging whether or not the face image and the gesture image set are normal ones. With the arrangement, the captured image analyzer 813 can be simplified, so that the cost of the navigation device 700 can further be reduced. In addition, the processes of Steps S205, S302, S303, S310, and S311 can be appropriately omitted. Accordingly, processing load in the process state setting and the image analysis performed by the captured image analyzer 813 can be reduced.

The captured image analyzer 813 may not output the gesture requesting voice, but capture the gesture image set appropriately made by the user. With the arrangement, the captured image analyzer 813 may not include a function for outputting the gesture requesting voice, thereby simplifying the arrangement of the captured image analyzer 813. Accordingly, the cost of the navigation device 700 can be reduced. In addition, the process of Step 308 can be appropriately omitted, thus further reducing the processing load in the image analysis performed by the process state setting unit 810.

The state setting controller 815 may be so arranged that, in a case where the user wears glasses or a facemask and it is recognized that user-specific setting information 910 corresponding to the face image is not stored in the memory 730, when a certain setting (e.g., input of a security code) is recognized, the components 820, 330, 850 are locked. With the arrangement, the navigation device 700 can be used only by the user whose user-specific setting information 910 has been registered. In addition, by employing an arrangement in which the components are unlocked by an input of a security code or the like, processes can be appropriately performed in accordance with a registered user even when the registered user wears sunglasses or a facemask and the face image does not match with the normal face image registered in the registration face information 915.

It may be so arranged that, when the state setting controller 815 recognizes that the user-specific setting information 910 corresponding to the normal face image and the normal gesture image set is not stored in the memory 730, e.g., when a person who has not obtained a permission for using a vehicle from an owner of the vehicle turns on the navigation device 700 without the permission, the following processes are performed. Specifically, a normal face image and a normal gesture image set of this person are stored in the memory 730 or transmitted to a portable terminal unit of the owner. With the arrangement, the person who has not obtained the permission can be identified more securely as compared to an arrangement in which a voice of this person is stored in the memory 730 or transmitted to the portable terminal unit of the owner. Accordingly, the security of the navigation device 700 can be enhanced.

The setting information generator 816 may include a function below. Specifically, when recognizing that the user specific information 513 of the user-specific setting information that is generated based on the normal face image and the normal gesture image set and does not contain the information 511, 512 and the user specific information 513 of the user-specific setting information 910 that is generated based on the destination-responding voice and does not contain the information 915, 916 match with each other, the function provided to the setting information generator 816 may combine these user-specific setting information 910 into one piece of user-specific setting information 910. With the arrangement, the number of pieces of user-specific setting information 910 stored in the memory 730 can be reduced. Accordingly, process loading in the retrieval of the user-specific setting information 910 performed by the state setting controller 815 can be reduced.

The present invention is applicable to, without limiting to the navigation device 700, any arrangement performing output of information such as music reproducing device that reproduces only music, a radio device that outputs a radio voice, a television device that outputs a television image, a content reproducing device that reproduces content recorded in a recording medium such as a DVD and a game console. In other words, the present invention is applicable to an arrangement installed in homes or the like without limiting to an arrangement installed in a mobile body. In addition, the present invention is also applicable to various portable devices as described above such as a portable phone. For example, a voice “The vehicle is making a right turn” in operating an indicator or a voice “The vehicle is backing” in operating a gear of the vehicle may be output in accordance with the user. Without limiting to an arrangement in which the process control device is applied to the navigation device 700, the process control device is applicable to a process state setting device, which is the process state setting unit 810 arranged as a standalone device.

The specific structures and the operating procedures for the present invention may be appropriately modified as long as the object of the present invention can be achieved.

### Advantages of Embodiments

As described above, in the embodiments above, the processor 300 of the navigation device 200 operates the response voice analyzer 311 of the process state setting unit 310 to acquire the destination-responding voice collected by the microphone 230. Then, the state setting controller 313 of the process state setting unit 310 performs a control such that the user of the vehicle is identified based on the destination-responding voice and the navigation processor 320 and the music reproducing unit 330 perform processes according to the identified user. Accordingly, the navigation device 200 can perform the travel route search, the music selection and the setting of the output form of the music in accordance with the user's preference without necessity for the user to input the process states of the navigation processor 320 and the music reproducing unit 330.

The processor 800 of the navigation device 700 operates the captured image analyzer 813 of the process state setting unit 810 to acquire the captured image information of the face image and the gesture image set captured by the image capturing section 710. Then, the state setting controller 815 of the process state setting unit 810 performs a control such that the user of the vehicle is identified based on the face image and the gesture image set of the captured image information acquired by the captured image analyzer 813 and such that the navigation processor 820, the music reproducing unit 330 and the content reproducing unit 850 perform processes in accordance with the identified user. Accordingly, the navigation device 700 can perform the travel route search, the music selection and the content reproduction in accordance with the user's preference without necessity for the user to input the process states of the navigation processor 820, the music reproducing unit 330 and the content reproducing unit 850.

The navigation device 700 operates the process state setting unit 810 of the process state setting unit 810 to set the components 820, 330, 850 such that various information output in use of the vehicle is output using an output form according to the user identified by, for instance, the destination-responding voice. Accordingly, the navigation device 700 can output the various information output in use of the vehicle in accordance with the user's preference without necessity for the user to input the process states of the components 820, 330, 850.

The navigation device 700 performs a control such that the components 330, 850 reproduce music and content with reproduction states according to the user identified based on, for instance, the destination-responding voice. Accordingly, the navigation device 700 can perform the reproduction of the music and the content in accordance with the user's preference without necessity for the user to input the process states of the components 330, 850.

### INDUSTRIAL APPLICABILITY

The present invention is applicable to a process control device for supporting a travel of a mobile body, its method, its program and a recording medium storing the program.

1: A process control device, comprising:
a usage state information acquirer that acquires usage state information about a usage state of a mobile body using a travel support function that supports a travel of the mobile body;
a user identification section that identifies a user of the mobile body based on the usage state of the usage state information;
an information selection processor that performs an information selection for selecting predetermined information to be output in use of the mobile body; and
an information selection process controller that controls the information selection processor to perform the information selection in accordance with the identified user, wherein
the information is content data,
the content data is an image,
the information selection processor is an image selection process controller that performs an image selection for selecting a predetermined image as the information selection, and
the information selection process controller is an image selection process controller that controls the image selection processor to perform the image selection in accordance with the identified user.

2. A process control device, comprising:
a usage state information acquirer that acquires usage state information about a usage state of a mobile body using a travel support function that supports a travel of the mobile body;
a user identification section that identifies a user of the mobile body based on the usage state of the usage state information;
an information output processor that performs an information output for outputting predetermined information to be output in use of the mobile body; and
an information output process controller that controls the information output processor to output the information using an output form according to the identified user, wherein
the information is content data,
the content data is an image,
the information output processor is an image display processor that performs an image display for displaying a predetermined image as the information output, and
the information output process controller is an image display process controller that controls the image display processor to display the image using a display form as the reproduction form according to the identified user.

3. A process control device, comprising:
a usage state information acquirer that acquires usage state information about a usage state of a mobile body using a travel support function that supports a travel of the mobile body;
a user identification section that identifies a user of the mobile body based on the usage state of the usage state information;
a music selection processor that performs a music selection for selecting predetermined music; and
a music selection process controller that controls the music selection processor to perform the music selection in accordance with the identified user, wherein
the usage state information is information about at least one of a current position, a stop-by point and a destination of the mobile body, and
the user identification section identifies the user based on at least one of the current position, the stop-by point and the destination.

4. A process control device, comprising:
a usage state information acquirer that acquires usage state information about a usage state of a mobile body using a travel support function that supports a travel of the mobile body;
a user identification section that identifies a user of the mobile body based on the usage state of the usage state information;
a music selection processor that performs a music selection for selecting predetermined music; and
a music selection process controller that controls the music selection processor to perform the music selection in accordance with the identified user, wherein
the usage state information is information about a time and date when the mobile body is used, and
the user identification section identified the user based on the time and date.

5. A process control device, comprising:
a characteristic information acquirer that acquires characteristic information about a characteristic of a user;
a user identification section that identifies the user based on the characteristic of the characteristic information;
an information selection processor that performs an information selection for selecting predetermined information; and
an information selection process controller that controls the information selection processor to perform the information selection in accordance with the identified user, wherein
the characteristic information is usage state information about a usage state of a mobile body using a travel support function that supports a travel of the mobile body,
the information is content data,
the content data is an image,
the information selection processor is an image selection processor that performs an image selection for selecting a predetermined image as the information selection, and
the information selection process controller is an image selection process controller that controls the image selection processor to perform the image selection in accordance with the identified user.

6. A process control device, comprising:
a characteristic information acquirer that acquires characteristic information about a characteristic of a user;
a user identification section that identifies the user based on the characteristic of the characteristic information;
an information output processor that performs an information output for outputting predetermined information; and
an information output process controller that controls the information output processor to output the information using an output form according to the identified user, wherein
the information is content data,
the content data is an image,
the information output processor is an image display processor that performs an image display for displaying a predetermined image as the information output, and
the information output process controller is an image display process controller that controls the image display processor to display the image using a display form as the reproduction form according to the identified user.

7. The process control device according to claim 6, further comprising:
the characteristic information is usage state information about a usage state of a mobile body using a travel support function that supports a travel of the mobile body.

8. The process control device according to claim 2, wherein the image display process controller performs a control such that at least one of a brightness, a hue and a chroma is the display form of the image is set in accordance with the identified user.

9. The process control device according to claim 6, wherein
the image display process controller performs a control such that at least one of a brightness, a hue and a chroma in the display form of the image is set in accordance with the identified user.

10. The process control device according to claim 5, further comprising:
the characteristic of the user is at least one of a gesture and a biological characteristic.

11. The process control device according to claim 6, further comprising:
the characteristic of the user is at least one of a gesture and a biological characteristic.

12. A process control device, comprising:
a usage state information acquirer that acquires usage state information about a usage state of a mobile body using a travel support function that supports a travel of the mobile body;
a user identification section that identifies a user of the mobile body based on the usage state of the usage state information;
a music output processor that performs a music output for outputting predetermined music; and
a music output process controller that controls the music output processor to output the music using an output form according to the identified user, wherein
the usage state information is information about at least one of a current position, a stop-by point and a destination of the mobile body, and
the user identification section identifies the user based on at least one of the current position, the stop-by point and the destination.

13. The process control device, comprising:
a usage state information acquirer that acquires usage state information about a usage state of a mobile body using a travel support function that supports a travel of the mobile body;
a user identification section that identifies a user of the mobile body based on the usage state of the usage state information;
an information selection processor that performs information selection for selecting predetermined information to be output in use of the mobile body; and
an information selection process controller that controls the information selection processor to perform the information selection in accordance with the identified user, wherein
the usage state information is information about at least one of a current position, a stop-by point and a destination of the mobile body, and
the user identification section identifies the user based on at least one of the current position, the stop-by point and the destination.

14. A process control device, comprising:
a usage state information acquirer that acquires usage state information about a usage state of a mobile body using a travel support function that supports a travel of the mobile body;
a user identification section that identifies a user of the mobile body based on the usage state of the usage state information;
an information output processor that performs information output for outputting predetermined information to be output in use of the mobile body; and
an information output process controller that controls the information output processor to output the information using an output form according to the identified user, wherein
the usage state information is information about at least one of a current position, a stop-by point and a destination of the mobile body, and
the user identification section identifies the user based on at least one of the current position, the stop-by point and the destination.

15. A process control device, comprising:
a characteristic information acquirer that acquires characteristic information about a characteristic of a user;
a user identification section that identifies the user based on the characteristic of the characteristic information;
an information selection processor that performs an information selection for selecting predetermined information; and
an information selection process controller that controls the information selection processor to perform the information selection in accordance with the identified user, wherein
the characteristic information is usage state information about a usage state of a mobile body using a travel support function that supports a travel of the mobile body,
the usage state information is information about at least one of a current position, a stop-by point and a destination of the mobile body, and
the user identification section identifies the user based on at least one of the current position, the stop-by point and the destination.

16. A process control device, comprising:
a characteristic information acquirer that acquires characteristic information about a characteristic of a user;
a user identification section that identifies the user based on the characteristic of the characteristic information;
an information output processor that performs an information output for outputting predetermined information; and
an information output process controller that controls the information output processor to output the information using an output form according to the identified user, wherein
the characteristic information is usage state information about a usage state of a mobile body using a travel support function that supports a travel of the mobile body,
the usage state information is information about at least one of a current position, a stop-by point and a destination of the mobile body, and
the user identification section identifies the user based on at least one of the current position, the stop-by point and the destination.

17. The process control device according to claim 3, wherein
the usage state information is information utilizing a biological characteristic, and
the user identification section identifies the user based on the biological characteristic.

18. The process control device according to claim 12, wherein
the usage state information is information utilizing a biological characteristic, and
the user identification section identifies the user based on the biological characteristic.

19. The process control device according to claim 13, wherein
the usage state information is information is information utilizing a biological characteristic, and
the user identification section identifies the user based on the biological characteristic.

20. The process control device according to claim 14, wherein
the usage state information is information utilizing a biological characteristic, and
the user identification section identifies the user based on the biological characteristic.

21. The process control device according to claim 15, wherein
the usage state information is information utilizing a biological characteristic, and
the user identification section identifies the user based on the biological characteristic.

22. The process control device according to claim 16, wherein
the usage state information is information utilizing a biological characteristic, and
the user identification section identifies the user based on the biological characteristic.

23. The process control device according to claim 3, wherein the biological characteristic is a characteristic about a voice.

24. The process control device according to claim 5, wherein the biological characteristic is a characteristic about a voice.

25. The process control device according to claim 6, wherein the biological characteristic is a characteristic about a voice.

26. The process control device according to claim 12, wherein the biological characteristic is a characteristic about a voice.

27. The process control device according to claim 13, wherein the biological characteristic is a characteristic about a voice.

28. The process control device according to claim 14, wherein the biological characteristic is a characteristic about a voice.

29. The process control device according to claim 15, wherein the biological characteristic is a characteristic about a voice.

30. The process control device according to claim 16, wherein the biological characteristic is a characteristic about a voice.

31. A process control device, comprising:
a usage state information acquirer that acquires usage state information about a usage state of a mobile body using a travel support function that supports a travel of the mobile body;
a user identification section that identifies a user of the mobile body based on the usage state of the usage state information;
a music output processor that performs a music output for outputting predetermined music; and
a music output process controller that controls the music output processor to output the music using an output form according to the identified user, wherein
the usage state information is information about a time and date when the mobile body is used, and
the user identification section identifies the user based on the time and date.

32. A process control device, comprising:
a usage state information acquirer that acquires usage state information about a usage state of a mobile body using a travel support function that supports a travel of the mobile body;
a user identification section that identifies a user of the mobile body based on the usage state of the usage state information;
an information selection processor that performs information selection for selecting predetermined information to be output in use of the mobile body; and
an information selection process controller that controls the information selection processor to perform the information selection in accordance with the identified user, wherein
the usage state information is information about a time and date when the mobile body is used, and
the user identification section identifies the user based on the time and date.

33. A process control device, comprising:
a usage state information acquirer that acquires usage state information about a usage state of a mobile body using a travel support function that supports a travel of the mobile body;
a user identification section that identifies a user of the mobile body based on the usage state of the usage state information;
an information output processor that performs information output for outputting predetermined information to be output in use of the mobile body; and
an information output process controller that controls the information output processor to output the information using an output form according to the identified user, wherein
the usage state information is information about a time and date when the mobile body is used, and
the user identification section identifies the user based on the time and date.

34. A process control device, comprising:
a characteristic information acquirer that acquires characteristic information about a characteristic of a user;
a user identification section that identifies the user based on the characteristic of the characteristic information;
an information selection processor that performs an information selection for selecting predetermined information; and
an information selection process controller that controls the information selection processor to perform the information selection in accordance with the identified user, wherein
the characteristic information is usage state information about a usage state of a mobile body using a travel support function that supports a travel of the mobile body,
the usage state information is information about a time and date when the mobile body is used, and
the user identification section identifies the user based on the time and date.

35. A process control device, comprising:
a characteristic information acquirer that acquires characteristic information about a characteristic of a user;
a user identification section that identifies the user based on the characteristic of the characteristic information;
an information output processor that performs an information output for outputting predetermined information; and
an information output process controller that controls the information output processor to output the information using an output form according to the identified user, wherein
the characteristic information is usage state information about a usage state of a mobile body using a travel support function that supports a travel of the mobile body,
the usage state information is information about a time and date when the mobile body is used, and
the user identification section identifies the user based on the time and date.

36. A process control program that operates a computing section to function as a process control device that includes: a usage state information acquirer that acquires usage state information about a usage state of a mobile body using a travel support function that supports a travel of the mobile body; a user identification section that identifies a user of the mobile body based on the usage state of the usage state information; an information selection processor that performs an information selection for selecting predetermined information to be output in use of the mobile body; and an information selection process controller that controls the information selection processor to perform the information selection in accordance with the identified user, wherein
the information is content data,
the content data is an image,
the information selection processor is an image selection process controller that performs an image selection for selecting a predetermined image as the information selection, and
the information selection process controller is an image selection process controller that controls the image selection processor to perform the image selection in accordance with the identified user.

37. A process control program that operates a computing section to function as a process control device that includes: a usage state information acquirer that acquires usage state information about a usage state of a mobile body using a travel support function that supports a travel of the mobile body; a user identification section that identifies a user of the mobile body based on the usage state of the usage state information; an information output processor that performs an information output for outputting predetermined information to be output in use of the mobile body; and an information output process controller that controls the information output processor to output the information using an output form according to the identified user, wherein
the information is content data,
the content data is an image,
the information output processor is an image display processor that performs an image display for displaying a predetermined image as the information output, and
the information output process controller is an image display process controller that controls the image display processor to display the image using a display form as the reproduction form according to the identified user.

38. A process control program that operates a computing section to function as a process control device that includes: a usage state information acquirer that acquires usage state information about a usage state of a mobile body using a travel support function that supports a travel of the mobile body; a user identification section that identifies a user of the mobile body based on the usage state of the usage state information; a music selection processor that performs a music selection for selecting predetermined music; and a music selection process controller that controls the music selection processor to perform the music selection in accordance with the identified user, wherein
the usage state information is information about at least one of a current position, a stop-by point and a destination of the mobile body, and
the user identification section identifies the user based on at least one of the current position, the stop-by point and the destination.

39. A process control program that operates a computing section to function as a process control device that includes: a usage state information acquirer that acquires usage state information about a usage state of a mobile body using a travel support function that supports a travel of the mobile body; a user identification section that identifies a user of the mobile body based on the usage state of the usage state information; a music selection processor that performs a music selection for selecting predetermined music; and a music selection process controller that controls the music selection processor to perform the music selection in accordance with the identified user, wherein
the usage state information is information about a time and date when the mobile body is used, and
the user identification section identifies the user based on the time and date.

40. A process control program that operates a computing section to function as a process control device that includes: a characteristic information acquirer that acquires characteristic information about a characteristic of a user; a user identification section that identifies the user based on the characteristic of the characteristic information; an information selection processor that performs an information selection for selecting predetermined information; and an information selection process controller that controls the information selection processor to perform the information selection in accordance with the identified user, wherein
the characteristic information is usage state information about a usage state of a mobile body using a travel support function that supports a travel of the mobile body,
the information is content data,
the content data is an image,
the information selection processor is an image selection processor that performs an image selection for selecting a predetermined image as the information selection, and
the information selection process controller is an image selection process controller that controls the image selection processor to perform the image selection in accordance with the identified user.

41. A process control program that operates a computing section to function as a process control device that includes: a characteristic information acquirer that acquires characteristic information about a characteristic of a user; a user identification section that identifies the user based on the characteristic of the characteristic information; an information output processor that performs an information output for outputting predetermined information; and an information output process controller that controls the information output processor to output the information using an output form according to the identified user, wherein
the information is content data,
the content data is an image,
the information output processor is an image display processor that performs an image display for displaying a predetermined image as the information output, and
the information output process controller is an image display process controller that controls the image display processor to display the image using a display form as the reproduction form according to the identified user.

42. A process control program that operates a computing section to function as a process control device that includes: a usage state information acquirer that acquires usage state information about a usage state of a mobile body using a travel support function that supports a travel of the mobile body; a user identification section that identifies a user of the mobile body based on the usage state of the usage state information; a music output processor that performs a music output for outputting predetermined music; and a music output process controller that controls the music output processor to output the music using an output form according to the identified user, wherein
the usage state information is information about at least one of a current position, a stop-by point and a destination of the mobile body, and
the user identification section identifies the user based on at least one of the current position, the stop-by point and the destination.

43. A process control program that operates a computing section to function as a process control device that includes: a usage state information acquirer that acquires usage state information about a usage state of a mobile body using a travel support function that supports a travel of the mobile body; a user identification section that identifies a user of the mobile body based on the usage state of the usage state information; an information selection processor that performs information selection for selecting predetermined information to be output in use of the mobile body; and an information selection process controller that controls the information selection processor to perform the information selection in accordance with the identified user, wherein
the usage state information is information about at least one of a current position, a stop-by point and a destination of the mobile body, and
the user identification section identifies the user based on at least one of the current position, the stop-by point and the destination.

44. A process control program that operates a computing section to function as a process control device that includes: a usage state information acquirer that acquires usage state information about a usage state of a mobile body using a travel support function that supports a travel of the mobile body; a user identification section that identifies a user of the mobile body based on the usage state of the usage state information; an information output processor that performs information output for outputting predetermined information to be output in use of the mobile body; and an information output process controller that controls the information output processor to output the information using an output form according to the identified user, wherein
the usage state information is information about at least one of a current position, a stop-by point and a destination of the mobile body, and
the user identification section identifies the user based on at least one of the current position, the stop-by point and the destination.

45. A process control program that operates a computing section to function as a process control device that includes: a characteristic information acquirer that acquires characteristic information about a characteristic of a user; a user identification section that identifies the user based on the characteristic of the characteristic information; an information selection processor that performs an information selection for selecting predetermined information; and an information selection process controller that controls the information selection processor to perform the information selection in accordance with the identified user, wherein
the characteristic information is usage state information about a usage state of a mobile body using a travel support function that supports a travel of the mobile body,
the usage state information is information about at least one of a current position, a stop-by point and a destination of the mobile body, and
the user identification section identifies the user based on at least one of the current position, the stop-by point and the destination.

46. A process control program that operates a computing section to function as a process control device that includes: a characteristic information acquirer that acquires characteristic information about a characteristic of a user; a user identification section that identifies the user based on the characteristic of the characteristic information; an information output processor that performs an information output for outputting predetermined information; and an information output process controller that controls the information output processor to output the information using an output form according to the identified user, wherein
the characteristic information is usage state information about a usage state of a mobile body using a travel support function that supports a travel of the mobile body,
the usage state information is information about at least one of a current position, a stop-by point and a destination of the mobile body, and
the user identification section identifies the user based on at least one of the current position, the stop-by point and the destination.

47. A process control program that operates a computing section to function as a process control device that includes: a usage state information acquirer that acquires usage state information about a usage state of a mobile body using a travel support function that supports a travel of the mobile body; a user identification section that identifies a user of the mobile body based on the usage state of the usage state information; a music output processor that performs a music output for outputting predetermined music; and a music output process controller that controls the music output processor to output the music using an output form according to the identified user, wherein
the usage state information is information about a time and date when the mobile body is used, and
the user identification section identifies the user based on the time and date.

48. A process control program that operates a computing section to function as a process control device that includes: a usage state information acquirer that acquires usage state information about a usage state of a mobile body using a travel support function that supports a travel of the mobile body; a user identification section that identifies a user of the mobile body based on the usage state of the usage state information; an information selection processor that performs information selection for selecting predetermined information to be output in use of the mobile body; and an information selection process controller that controls the information selection processor to perform the information selection in accordance with the identified user, wherein
the usage state information is information about a time and date when the mobile body is used, and
the user identification section identifies the user based on the time and date.

49. A process control program that operates a computing section to function as a process control device that includes: a usage state information acquirer that acquires usage state information about a usage state of a mobile body using a travel support function that supports a travel of the mobile body; a user identification section that identifies a user of the mobile body based on the usage state of the usage state information; an information output processor that performs information output for outputting predetermined information to be output in use of the mobile body; and an information output process controller that controls the information output processor to output the information using an output form according to the identified user, wherein
the usage state information is information about a time and date when the mobile body is used, and
the user identification section identifies the user based on the time and date.

50. A process control program that operates a computing section to function as a process control device that includes: a characteristic information acquirer that acquires characteristic information about a characteristic of a user; a user identification section that identifies the user based on the characteristic of the characteristic information; an information selection processor that performs an information selection for selecting predetermined information; and an information selection process controller that controls the information selection processor to perform the information selection in accordance with the identified user, wherein
the characteristic information is usage state information about a usage state of a mobile body using a travel support function that supports a travel of the mobile body,
the usage state information is information about a time and date when the mobile body is used, and
the user identification section identifies the user based on the time and date.

51. A process control program that operates a computing section to function as a process control device that includes: a characteristic information acquirer that acquires characteristic information about a characteristic of a user; a user identification section that identifies the user based on the characteristic of the characteristic information; an information output processor that performs an information output for outputting predetermined information; and an information output process controller that controls the information output processor to output the information using an output form according to the identified user, wherein
the characteristic information is usage state information about a usage state of a mobile body using a travel support function that supports a travel of the mobile body,
the usage state information is information about a time and date when the mobile body is used, and
the user identification section identifies the user based on the time and date.
